(19) United States
(12) Patent Application Publication
(10) Pub. No.: US 2026/0067611 A1
(43) Pub. Date: Mar. 5, 2026

(54) VENTED SPEAKER ASSEMBLY

(71) Applicant: ALPS ALPINE CO., LTD., TOKYO (JP)

(72) Inventor: Rory Buszka, Novi, MI (US)

(21) Appl. No.: 18/825,633

(22) Filed: Sep. 5, 2024

(51) Int. Cl. H04R 1/28; H04R 1/02; H04R 9/02

(52) U.S. Cl. CPC H04R 1/2849; H04R 1/023; H04R 1/2857; H04R 9/025; H04R 2499/13

(57) ABSTRACT

A loudspeaker system may include a pressure vessel, an active acoustic radiator, an acoustic channel, and a vent. The pressure vessel can be disposed outside a vehicle enclosure. The pressure vessel can be configured to maintain a controlled environment different from an environment outside both the pressure vessel and the vehicle enclosure. The active acoustic radiator can be disposed within the pressure vessel and may radiate acoustic emissions outside the vehicle enclosure. The active acoustic radiator comprising magnetic circuit, a moveable diaphragm, and a voice coil. The acoustic channel can fluidly connect an interior of the pressure vessel with an interior of the vehicle enclosure. The acoustic channel can radiate acoustic emissions into the interior of the vehicle enclosure that are substantially in-phase with the acoustic emissions generated outside the vehicle by the active acoustic radiator within a range of operating frequencies. The vent can connect the interior of the pressure vessel to the environment outside both the pressure vessel and the vehicle enclosure. The resulting system provides efficient sound generation both inside and outside of a vehicle interior, without the efficiency or sound fidelity compromises of prior systems.

### BACKGROUND

### Field of the Invention

Various embodiments of this application relate to the field of loudspeaker design. More specifically to loudspeaker enclosure designs that provide improved acoustic radiation efficiency at low frequencies without compromising acoustic radiation efficiency at mid and high frequency ranges, or in dedicated low-frequency loudspeakers.

### Description of the Related Art

A loudspeaker is a device that converts electrical audio signals to sound waves radiated out of the loudspeaker. A loudspeaker typically includes one or more speaker drivers mounted on an enclosure designed to improve acoustic radiation efficiency and the spectral fidelity of the radiated sound waves. The speaker driver converts electrical audio signals to sound waves, radiates a portion of the sound waves away from the enclosure and another portion into the enclosure. The enclosure sustains and filters the internally radiated portion of the sound waves and radiates them out of the enclosure via an opening (such as a port tube) or using a passive radiator. The design of the enclosure can significantly affect the acoustic radiation efficiency in particular at low audio frequencies. Such loudspeakers and systems thereof can be included inside or outside vehicle interiors and may be part of vehicle audio systems or active noise cancellation systems.

### SUMMARY

In some embodiments, a pressure vessel can be disposed outside a vehicle interior (e.g. the typically or substantially enclosed cabin air volume of a vehicle). The pressure vessel can be configured to maintain a controlled environment different from an environment outside both the pressure vessel and the vehicle interior. The active acoustic radiator can be disposed within the pressure vessel and radiate acoustic emissions outside the vehicle interior via an acoustic channel, vent, or other opening. The active acoustic radiator normally comprises a magnetic circuit and a moveable diaphragm. A separate acoustic channel can fluidly connect an interior of the pressure vessel with an interior of the vehicle enclosure. The acoustic channel can radiate acoustic emissions into the interior of the vehicle enclosure that are in-phase with the acoustic emissions generated by the active acoustic radiator into the exterior of the vehicle enclosure. Acoustic emissions generated by the active acoustic radiator may be further filtered or improved by inclusion of an acoustic filter on a second side of the diaphragm of the active acoustic radiator, and then radiated into the exterior area via a separate opening or vent. The vent can connect the interior of the pressure vessel to the environment outside both the pressure vessel and the vehicle enclosure.

### BRIEF DESCRIPTION OF THE DRAWINGS

The systems, methods, and devices of this disclosure each have several innovative aspects, no single one of which is solely responsible for all of the desirable attributes disclosed herein. Many forms or additional implementations are possible which substantially employ the novel conceptual material of the present invention. A person of ordinary skill in the art may, after reviewing this disclosure, identify additional embodiments or possible transformations of the elements disclosed which do not substantially alter the novel functionality of the present invention. Details of one or more implementations of the subject matter described in this specification are set forth in the accompanying drawings and the description below.

FIG. 1 schematically illustrates a loudspeaker system with a pressure vessel with a single chamber with an accessory air path to an interior of a vehicle enclosure and an exterior port pipe to an environment.

FIG. 2 schematically illustrates a loudspeaker system with a pressure vessel with two chambers, wherein the first chamber includes a passive acoustic radiator and an active acoustic radiator, and the second chamber includes an accessory air path to an interior of a vehicle enclosure and an exterior port pipe to an environment.

FIG. 3 schematically illustrates a loudspeaker system with a pressure vessel with two chambers, wherein the first chamber includes an active acoustic radiator, and the second chamber includes an accessory air path to an interior of a vehicle enclosure and an exterior port pipe to an environment.

FIG. 4 schematically illustrates a loudspeaker system with a pressure vessel with two chambers, wherein the first chamber includes an active acoustic radiator, and the second chamber includes an interior port pipe to an interior of a vehicle enclosure and an exterior port pipe to an environment.

FIG. 5 schematically illustrates a loudspeaker system with a pressure vessel with two chambers, wherein the first chamber includes an active acoustic radiator and an exterior port pipe to an environment, and the second chamber includes an accessory air path to an interior of a vehicle enclosure and an exterior port pipe to the environment.

FIG. 6 schematically illustrates a loudspeaker system with a pressure vessel with three chambers, wherein a first chamber includes an active acoustic radiator and passive acoustic radiator, the second chamber includes an accessory air path to an interior of a vehicle enclosure and an exterior port pipe to an environment, and the third chamber includes an exterior port pipe to an environment.

FIG. 7 schematically illustrates a loudspeaker system with a pressure vessel with three chambers, wherein a first chamber includes an active acoustic radiator and passive acoustic radiator, the second chamber includes an exterior port pipe to an environment, and the third chamber includes an accessory air path to an interior of a vehicle enclosure and an exterior port pipe to an environment.

FIG. 8 schematically illustrates a loudspeaker system with a pressure vessel with two chambers, wherein a first chamber includes an active acoustic radiator and passive acoustic radiator and the second chamber includes an exterior port pipe to an environment and an accessory air path to an interior of a vehicle enclosure.

FIG. 9 schematically illustrates a loudspeaker system with a pressure vessel with three chambers, wherein a first chamber includes an active acoustic radiator and passive acoustic radiator, the second chamber includes interior port pipe to an interior of a vehicle enclosure, and the third chamber includes an exterior port pipe to an environment.

FIG. 10 schematically illustrates a prior art loudspeaker system with a pressure vessel with a single chamber including an active acoustic radiator and an interior port pipe to an interior of a vehicle enclosure.

FIG. 11 schematically illustrates a prior art loudspeaker system with a pressure vessel with two chambers, wherein the first chamber includes an active acoustic radiator and an interior port pipe to an interior of a vehicle enclosure and the second chamber includes an exterior port pipe to an environment.

FIG. 12 schematically illustrates a prior art loudspeaker system with a pressure vessel with two chambers, wherein the first chamber includes an active acoustic radiator and the second chamber includes an exterior port pipe to an environment.

FIG. 13 schematically illustrates a prior art loudspeaker system with a pressure vessel with two chambers, wherein the first chamber includes an active acoustic radiator and an exterior port pipe to an environment and the second chamber includes an exterior port pipe to the environment.

FIG. 14 schematically illustrates a prior art loudspeaker system with a pressure vessel with two chambers, wherein the first chamber includes an active acoustic radiator and an interior port pipe to an interior of a vehicle enclosure.

FIG. 15 schematically illustrates a prior art loudspeaker system with a pressure vessel with two chambers, wherein the first chamber includes an active acoustic radiator and an interior port pipe to an interior of a vehicle enclosure and the second chamber includes an interior port pipe to the interior of the vehicle enclosure.

FIG. 16 schematically illustrates a loudspeaker system with a pressure vessel with three chambers, wherein the first chamber includes an active acoustic radiator, a passive acoustic radiator, and an accessory air path with a resistive element to an interior of a vehicle enclosure, the second chamber includes an exterior port pipe to an environment, and the third chamber includes an exterior port pipe to the environment.

FIG. 17 schematically illustrates a loudspeaker system with a pressure vessel with three chambers, wherein the first chamber includes an active acoustic radiator and a passive acoustic radiator, the second chamber includes an exterior port pipe to an environment and an accessory air path to an interior of a vehicle enclosure, and the third chamber includes an exterior port pipe to the environment and an accessory air path to the interior of the vehicle enclosure.

FIG. 18 schematically illustrates a loudspeaker system with a pressure vessel with four chambers, wherein the first chamber includes an active acoustic radiator and a passive acoustic radiator, the second chamber includes a passive acoustic radiator, the third chamber includes an exterior port pipe to an environment, and the fourth chamber includes an accessory air path to the interior of the vehicle enclosure and an exterior port pipe to the environment.

FIG. 19 schematically illustrates a loudspeaker system with a pressure vessel with four chambers, wherein the first chamber includes an active acoustic radiator and a passive acoustic radiator, the second chamber includes a passive acoustic radiator and an accessory air path with a resistive element to the interior of a vehicle enclosure, the third chamber includes an exterior port pipe to an environment, and the fourth chamber includes an exterior port pipe to the environment.

FIG. 20 schematically illustrates a loudspeaker system with a pressure vessel with four chambers, wherein the first chamber includes an active acoustic radiator and a passive acoustic radiator, the second chamber includes a passive acoustic radiator, the third chamber includes an exterior port pipe to an environment and an accessory air path to an interior of a vehicle enclosure, and the fourth chamber includes an exterior port pipe to the environment and an accessory air path to the interior of the vehicle enclosure.

FIG. 21 schematically illustrates a loudspeaker system with a pressure vessel with four chambers, wherein the first chamber includes an active acoustic radiator and a passive acoustic radiator, the second chamber includes a passive acoustic radiator with an accessory air path with a resistive element to an interior of the vehicle enclosure, the third chamber includes an exterior port pipe to an environment and an accessory air path to the interior of the vehicle enclosure, and the fourth chamber includes an exterior port pipe to the environment.

FIG. 22 schematically illustrates a loudspeaker system with a pressure vessel with three chambers, wherein the first chamber includes an active acoustic radiator and a passive acoustic radiator, the second chamber includes a passive acoustic radiator, and the third chamber includes an exterior port pipe to an environment and an accessory air path to an interior of a vehicle enclosure.

FIG. 23 schematically illustrates a loudspeaker system with a pressure vessel with three chambers, wherein the first chamber includes an active acoustic radiator and a passive acoustic radiator, the second chamber includes a passive acoustic radiator and an accessory air path with a resistive element to an interior of a vehicle enclosure, and the third chamber includes an exterior port pipe to an environment.

FIG. 24 schematically illustrates a loudspeaker system with a pressure vessel with three main chambers, wherein the first chamber includes two active acoustic radiators and an exterior port pipe to an environment, the second chamber includes an accessory air path to an interior of a vehicle enclosure and an exterior port pipe to the environment, and the third chamber includes an accessory air path to the interior of the vehicle enclosure and an exterior port pipe to the environment. The second and third chambers can each include an auxiliary chamber with an active acoustic radiator.

FIG. 25 schematically illustrates a loudspeaker system with a pressure vessel with three main chambers, wherein the first chamber includes two active acoustic radiators and an exterior port pipe to an environment, the second chamber includes an exterior port pipe to the environment, and the third chamber includes an exterior port pipe to the environment. The second and third chambers can each include an auxiliary chamber with an active acoustic radiator.

FIG. 26 schematically illustrates a loudspeaker system with a pressure vessel with three main chambers, wherein the first chamber includes two active acoustic radiators, an exterior port pipe to an environment, and an accessory air path to an interior of a vehicle enclosure, the second chamber includes an exterior port pipe to the environment, and the third chamber includes an exterior port pipe to the environment. The second and third chambers can each include an auxiliary chamber with an active acoustic radiator.

FIG. 27 schematically illustrates a loudspeaker system with a pressure vessel with three main chambers, wherein the first chamber includes two active acoustic radiators and an exterior port pipe to an environment, and the second chamber includes an accessory air path to an interior of a vehicle enclosure. The second and third chambers can each include an auxiliary chamber with an active acoustic radiator.

FIG. 28 schematically illustrates a loudspeaker system with a pressure vessel with three main chambers, wherein the first chamber includes two active acoustic radiators and an exterior port pipe to an environment, the second chamber includes an accessory air path to an interior of a vehicle enclosure, and the third chamber includes an accessory air path to the interior of the vehicle enclosure. The second and third chambers can each include an auxiliary chamber with an active acoustic radiator.

FIG. 29 schematically illustrates a loudspeaker system with a pressure vessel with three main chambers, wherein the first chamber includes two active acoustic radiators, an exterior port pipe to an environment, and an accessory air path to an interior of a vehicle enclosure. The second and third chambers can each include an auxiliary chamber with an active acoustic radiator.

FIG. 30 schematically illustrates a loudspeaker system with a pressure vessel with three main chambers, wherein the first chamber includes two active acoustic radiators and an accessory air path to an interior of a vehicle enclosure, the second chamber includes an exterior port pipe to an environment, and the third chamber includes an exterior port pipe to the environment. The second and third chambers can each include an auxiliary chamber with an active acoustic radiator.

FIG. 31 schematically illustrates a loudspeaker system with a pressure vessel with three main chambers, wherein the first chamber includes two active acoustic radiators, the second chamber includes an exterior port pipe to an environment and an accessory air path to an interior of a vehicle enclosure, and the third chamber includes an exterior port pipe to the environment. The second and third chambers can each include an auxiliary chamber with an active acoustic radiator.

FIG. 32 schematically illustrates a loudspeaker system with a pressure vessel with three main chambers, wherein the first chamber includes two active acoustic radiators, the second chamber includes an exterior port pipe to an environment and an accessory air path to an interior of a vehicle enclosure, and the third chamber includes an exterior port pipe to the environment and an accessory air path to the interior of the vehicle enclosure. The second and third chambers can each include an auxiliary chamber with an active acoustic radiator.

FIG. 33 schematically illustrates a loudspeaker system with a pressure vessel with three chambers, wherein the first chamber includes an active acoustic radiator and an interior port pipe to an interior of a vehicle enclosure and the second chamber includes an exterior port pipe to an environment. An interior port pipe can connect the first chamber and the third chamber.

FIG. 34 schematically illustrates a loudspeaker system with a pressure vessel with two chambers, wherein the first chamber includes an active acoustic radiator and an interior port pipe to an interior of the vehicle enclosure and the second chamber includes an interior port pipe to the interior of the vehicle enclosure and an exterior port pipe to an environment.

FIG. 35 schematically illustrates a loudspeaker system with a pressure vessel with two chambers, wherein first chamber includes an active acoustic radiator and exterior port pipe to an environment and the second chamber includes an interior port pipe to an interior of a vehicle enclosure and an exterior port pipe to the environment.

FIG. 36 schematically illustrates a loudspeaker system with a pressure vessel with two chambers, wherein the first chamber includes an active acoustic radiator, an exterior port pipe to an environment, and an interior port pipe to an interior of a vehicle enclosure and the second chamber includes an interior port pipe to the interior of the vehicle enclosure and an exterior port pipe to the environment.

FIG. 37 schematically illustrates a loudspeaker system with a pressure vessel with three chambers, wherein the first chamber includes an active acoustic radiator, the second chamber includes an exterior port pipe to an environment, and the third chamber includes an interior port pipe to an interior of a vehicle enclosure. An interior port pipe can connect the first chamber and the third chamber.

FIG. 38 schematically illustrates a loudspeaker system with a pressure vessel with three chambers, wherein the first chamber includes an active acoustic radiator, the second chamber includes an exterior port pipe to an environment, and the third chamber includes an interior port pipe to an interior of a vehicle enclosure and an exterior port pipe to the environment. An interior port pipe can connect the first chamber and the third chamber.

FIG. 39 schematically illustrates a loudspeaker system with a pressure vessel with three chambers, wherein the second chamber includes an active acoustic radiator and an interior port pipe to an interior of a vehicle enclosure and the third chamber includes an exterior port pipe to an environment. An interior port pipe can connect the first chamber and the third chamber.

FIG. 40 schematically illustrates a loudspeaker system with a pressure vessel with three chambers, wherein the first chamber includes an active acoustic radiator, the second chamber includes an exterior port pipe to an environment and an interior port pipe to an interior of a vehicle enclosure, and the third chamber includes an exterior port pipe to the environment. An interior port pipe can connect the first chamber and the third chamber.

FIG. 41 schematically illustrates a loudspeaker system with a pressure vessel with three chambers, wherein the first chamber includes an active acoustic radiator, the second chamber includes an exterior port pipe to an environment and an interior port pipe to an interior of a vehicle enclosure, and the third chamber includes an exterior port pipe to the environment and an interior port pipe to the interior of the vehicle enclosure. An interior port pipe can connect the first chamber and the third chamber.

FIG. 42 schematically illustrates a loudspeaker system with a pressure vessel with three chambers, wherein the first chamber includes two active acoustic radiators, the second chamber includes an interior port pipe to an interior of a vehicle enclosure, and the third chamber includes an exterior port pipe to an environment.

FIG. 43 schematically illustrates a loudspeaker system with a pressure vessel with three chambers, wherein the first chamber includes two active acoustic radiators, the second chamber includes an interior port pipe to an interior of a vehicle enclosure and an exterior port pipe to an environment, and the third chamber includes an exterior port pipe to the environment.

FIG. 44 schematically illustrates a loudspeaker system with a pressure vessel with three chambers, wherein the first chamber includes two active acoustic radiators and an interior port pipe to an interior of a vehicle enclosure, the second chamber includes an exterior port pipe to an environment, and the third chamber includes an exterior port pipe to the environment.

FIG. 45 schematically illustrates a loudspeaker system with a pressure vessel with three chambers, wherein the first chamber includes two active acoustic radiators and an exterior port pipe to an environment, the second chamber includes an exterior port pipe to the environment and an interior port pipe to an interior of a vehicle enclosure, and the third chamber includes an interior port pipe to the interior of the vehicle enclosure.

FIG. 46 schematically illustrates a loudspeaker system with a pressure vessel with three chambers, wherein the first chamber includes two active acoustic radiators and an exterior port pipe to an environment, the second chamber includes an interior port pipe to an interior of a vehicle enclosure, and the third chamber includes an interior port pipe to the interior of the vehicle enclosure.

FIG. 47 schematically illustrates a loudspeaker system with a pressure vessel with three chambers, wherein the first chamber includes two active acoustic radiators, the second chamber includes an exterior port pipe to an environment and an interior port pipe to an interior of a vehicle enclosure, and the third chamber includes an exterior port pipe to the environment and an interior port pipe to the interior of the vehicle enclosure.

FIG. 48 schematically illustrates a loudspeaker system with a pressure vessel with three chambers, wherein the first chamber includes two active acoustic radiators and an exterior port pipe to an environment, the second chamber includes an exterior port pipe to the environment and an interior port pipe to an interior of a vehicle enclosure, and the third chamber includes an exterior port pipe to the environment and an interior port pipe to the interior of the vehicle enclosure.

FIG. 49 schematically illustrates a loudspeaker system with a pressure vessel with three chambers, wherein the first chamber includes two active acoustic radiators, an interior port pipe to an interior of a vehicle enclosure, and an exterior port pipe to an environment, the second chamber includes an exterior port pipe to the environment and an interior port pipe to the interior of the vehicle enclosure, and the third chamber includes an exterior port pipe to the environment and an interior port pipe to the interior of the vehicle enclosure.

FIG. 50 schematically illustrates a loudspeaker system with a pressure vessel with three chambers, wherein the first chamber includes an active acoustic radiator and a passive acoustic radiator, the second chamber includes an exterior port pipe to an environment, and the third chamber includes an interior port pipe to an interior of an vehicle enclosure.

FIG. 51 schematically illustrates a loudspeaker system with a pressure vessel with three chambers, wherein the first chamber includes an active acoustic radiator and a passive acoustic radiator, the second chamber includes an interior port pipe to an interior of a vehicle enclosure and an exterior port pipe to an environment, and the third chamber includes an exterior port pipe to the environment.

FIG. 52 schematically illustrates a loudspeaker system with a pressure vessel with three chambers, wherein the first chamber includes an active acoustic radiator and a passive acoustic radiator, the second chamber includes an exterior port pipe to an environment, and the third chamber includes an interior port pipe to an interior of a vehicle enclosure and an exterior port pipe to the environment.

FIG. 53 schematically illustrates a loudspeaker system with a pressure vessel with three chambers, wherein the first chamber includes an active acoustic radiator and a passive acoustic radiator, the second chamber includes an exterior port pipe to an environment and an interior port pipe to an interior of a vehicle enclosure, and the third chamber includes an exterior port pipe to the environment and an interior port pipe to the interior of the vehicle enclosure.

FIG. 54 schematically illustrates a loudspeaker system with a pressure vessel with three chambers, wherein the second chamber includes an active acoustic radiator and the third chamber includes an exterior port pipe to an environment and an interior port pipe to an interior of a vehicle enclosure. An interior port pipe can connect the first chamber and the third chamber.

FIG. 55 schematically illustrates a loudspeaker system with a pressure vessel with three chambers, wherein the first chamber includes an exterior port pipe to an environment, the second chamber includes an active acoustic radiator, and the third chamber includes an interior port pipe to an interior of a vehicle enclosure. An interior port pipe can connect the first chamber and the third chamber.

FIG. 56 schematically illustrates a loudspeaker system with a pressure vessel with three chambers, wherein the first chamber includes an active acoustic radiator, the second chamber includes an exterior port pipe to an environment, and the third chamber includes an interior port pipe to an interior of a vehicle enclosure. An interior port pipe can connect the first chamber and the third chamber.

FIG. 57 schematically illustrates a loudspeaker system with a pressure vessel with three chambers, wherein the first chamber includes an active acoustic radiator and an exterior port pipe to an environment and the third chamber includes an exterior port pipe to the environment and an interior port pipe to an interior of a vehicle enclosure. An interior port pipe can connect the first chamber and the third chamber.

FIG. 58 schematically illustrates a loudspeaker system with a pressure vessel with three chambers, wherein the first chamber includes an active acoustic radiator, an exterior port pipe to an environment, and an interior port pipe to an interior of a vehicle enclosure and the third chamber includes an exterior port pipe to the environment. An interior port pipe can connect the first chamber and the third chamber.

FIG. 59 schematically illustrates a loudspeaker system with a pressure vessel with three chambers, wherein the first chamber includes an active acoustic radiator and an exterior port pipe to an environment, the second chamber includes an interior port pipe to an interior of a vehicle enclosure, and the third chamber includes an exterior port pipe to the environment. An interior port pipe can connect the first chamber and the third chamber.

FIG. 60 schematically illustrates a loudspeaker system with a pressure vessel with three chambers, wherein the first chamber includes an active acoustic radiator, an exterior port pipe to an environment, and an interior port pipe to an interior of a vehicle enclosure and the third chamber includes an interior port pipe to the interior of the vehicle enclosure and an exterior port pipe to the environment. An interior port pipe can connect the first chamber and the third chamber.

FIG. 61 schematically illustrates a loudspeaker system with a pressure vessel with three chambers, wherein the first chamber includes an active acoustic radiator, an exterior port pipe to an environment, and an interior port pipe to an interior of a vehicle enclosure, the second chamber includes an exterior port pipe to the environment, and the third chamber includes an interior port pipe to the interior of the vehicle enclosure. An interior port pipe can connect the first chamber and the third chamber.

FIG. 62 schematically illustrates a loudspeaker system with a pressure vessel with three chambers, wherein the first chamber includes an active acoustic radiator, an exterior port pipe to an environment, and an interior port pipe to an interior of a vehicle enclosure, the second chamber includes an exterior port pipe to the environment, and the third chamber includes an interior port pipe to the interior of the vehicle enclosure and an exterior port pipe to the environment. An interior port pipe can connect the first chamber and the third chamber.

FIG. 63 schematically illustrates a loudspeaker system with a pressure vessel with three chambers, wherein the first chamber includes an active acoustic radiator, an exterior port pipe to an environment, and an interior port pipe to an interior of a vehicle enclosure, the second chamber includes an interior port pipe to the interior of the vehicle enclosure, and the third chamber includes an exterior port pipe to the environment. An interior port pipe can connect the first chamber and the third chamber.

FIG. 64 schematically illustrates a loudspeaker system with a pressure vessel with three chambers, wherein the first chamber includes an active acoustic radiator, an exterior port pipe to an environment, and an interior port pipe to an interior of a vehicle enclosure and the second chamber includes an interior port pipe to the interior of the vehicle enclosure and an exterior port pipe to the environment. An interior port pipe can connect the first chamber and the third chamber.

FIG. 65 schematically illustrates a loudspeaker system with a pressure vessel with three chambers, wherein the first chamber includes an active acoustic radiator, an exterior port pipe to an environment, and an interior port pipe to an interior of a vehicle enclosure, the second chamber includes an interior port pipe to the interior of the vehicle enclosure and an exterior port pipe to the environment, and the third chamber includes an exterior port pipe to the environment. An interior port pipe can connect the first chamber and the third chamber.

FIG. 66 schematically illustrates a loudspeaker system with a pressure vessel with three chambers, wherein the first chamber includes an active acoustic radiator, an exterior port pipe to an environment, and an interior port pipe to an interior of a vehicle enclosure, the second chamber includes an interior port pipe to the interior of the vehicle enclosure and an exterior port pipe to the environment, and the third chamber includes an interior port pipe to the interior of the vehicle enclosure and an exterior port pipe to the environment. An interior port pipe can connect the first chamber and the third chamber.

FIG. 67 schematically illustrates a loudspeaker system with a pressure vessel with three chambers, wherein the first chamber includes an active acoustic radiator and an exterior port pipe to an environment and the third chamber includes an interior port pipe to an interior of a vehicle enclosure and an exterior port pipe to the environment. An interior port pipe can connect the first chamber and the third chamber.

FIG. 68 schematically illustrates a loudspeaker system with a pressure vessel with three chambers, wherein the first chamber includes an active acoustic radiator and an interior port pipe to an interior of a vehicle enclosure and the third chamber includes an exterior port pipe to an environment. An interior port pipe can connect the first chamber and the third chamber.

FIG. 69 schematically illustrates a loudspeaker system with a pressure vessel with three chambers, wherein the first chamber includes an active acoustic radiator, a passive acoustic radiator, and an interior port pipe to an interior of a vehicle enclosure, the second chamber includes an exterior port pipe to an environment, and the third chamber includes an exterior port pipe to the environment.

FIG. 70 schematically illustrates a loudspeaker system with a pressure vessel with three chambers, wherein the first chamber includes an active acoustic radiator and a passive acoustic radiator, the second chamber includes an exterior port pipe to an environment and an interior port pipe to an interior of a vehicle enclosure, and the third chamber includes an exterior port pipe to the environment and an interior port pipe to the interior of the vehicle enclosure.

FIG. 71 schematically illustrates a loudspeaker system with a pressure vessel with four chambers, wherein the first chamber includes an active acoustic radiator and a passive acoustic radiator, the second chamber includes a passive acoustic radiator, the third chamber includes an exterior port pipe to an environment, and the fourth chamber includes an interior port pipe to an interior of a vehicle enclosure and an exterior port pipe to the environment.

FIG. 72 schematically illustrates a loudspeaker system with a pressure vessel with four chambers, wherein the first chamber includes an active acoustic radiator and a passive acoustic radiator, the second chamber includes a passive acoustic radiator and an interior port pipe to an interior of a vehicle enclosure, the third chamber includes an exterior port pipe to an environment, and the fourth chamber includes an exterior port pipe to the environment.

FIG. 73 schematically illustrates a loudspeaker system with a pressure vessel with four chambers, wherein the first chamber includes an active acoustic radiator, a passive acoustic radiator, and an interior port pipe to an interior of a vehicle enclosure, the second chamber includes a passive acoustic radiator and an interior port pipe to the interior of the vehicle enclosure, the third chamber includes an exterior port pipe to an environment, and the fourth chamber includes an exterior port pipe to the environment.

FIG. 74 schematically illustrates a loudspeaker system with a pressure vessel with four chambers, wherein the first chamber includes an active acoustic radiator, a passive acoustic radiator, an interior port pipe to an interior of a vehicle enclosure, and an exterior port pipe to an environment, the second chamber includes a passive acoustic radiator, an interior port pipe to the interior of the vehicle enclosure, and an exterior port pipe to the environment, the third chamber includes an exterior port pipe to the environment, and the fourth chamber includes an exterior port pipe to the environment.

FIG. 75 schematically illustrates a loudspeaker system with a pressure vessel with four chambers, wherein the first chamber includes an active acoustic radiator and a passive acoustic radiator and the second chamber includes a passive acoustic radiator. Each of the first, second, third, and fourth chambers can include an interior port pipe to an interior of a vehicle enclosure and an exterior port pipe to an environment.

FIG. 76 schematically illustrates a loudspeaker system with a pressure vessel with four chambers, wherein the first chamber includes an active acoustic radiator and the second chamber includes a passive acoustic radiator. Each of the first, second, third, and fourth chambers can include an interior port pipe to an interior of a vehicle enclosure and an exterior port pipe to an environment. An interior port pipe can connect the first chamber and the third chamber.

FIG. 77 schematically illustrates a loudspeaker system with a pressure vessel with four chambers, wherein the first chamber includes an active acoustic radiator. Each of the first, second, third, and fourth chambers can include an interior port pipe to an interior of a vehicle enclosure and an exterior port pipe to an environment. An interior port pipe can connect the first chamber and the third chamber. An interior port pipe can connect the second chamber and the fourth chamber.

FIG. 78 schematically illustrates a loudspeaker system with a pressure vessel with three main chambers, wherein the first chamber includes two active acoustic radiators and an exterior port pipe to an environment, the second chamber includes an interior port pipe to an interior of a vehicle enclosure, and the third chamber includes an interior port pipe to the interior of the vehicle enclosure. The second and third chambers can each include an auxiliary chamber with an active acoustic radiator.

FIG. 79 schematically illustrates a loudspeaker system with a pressure vessel with three main chambers, wherein the first chamber includes two active acoustic radiators, an exterior port pipe to an environment, and an interior port pipe to an interior of a vehicle enclosure. The second and third chambers can each include an auxiliary chamber with an active acoustic radiator.

FIG. 80 schematically illustrates a loudspeaker system with a pressure vessel with three main chambers, wherein the first chamber includes two active acoustic radiators, the second chamber includes an interior port pipe to an interior of a vehicle enclosure and an exterior port pipe to an environment, and the third chamber includes an interior port pipe to the interior of the vehicle enclosure and an exterior port pipe to the environment. The second and third chambers can each include an auxiliary chamber with an active acoustic radiator.

FIG. 81 schematically illustrates a loudspeaker system with a pressure vessel with three main chambers, wherein the first chamber includes two active acoustic radiators and an interior port pipe to an interior of a vehicle enclosure, the second chamber includes an exterior port pipe to an environment, and the third chamber includes an exterior port pipe to the environment. The second and third chambers can each include an auxiliary chamber with an active acoustic radiator.

FIG. 82 schematically illustrates a prior art loudspeaker system with a pressure vessel with three chambers, wherein the first chamber includes two active acoustic radiators, the second chamber includes an exterior port pipe to an environment, and the third chamber includes an exterior port pipe to the environment.

FIG. 83 schematically illustrates a prior art loudspeaker system with a pressure vessel with three chambers, wherein the first chamber includes an active acoustic radiator and a passive acoustic radiator, the second chamber includes an exterior port pipe to an environment, and the third chamber includes an exterior port pipe to the environment.

FIG. 84 schematically illustrates a prior art loudspeaker system with a pressure vessel with three chambers, wherein the first chamber includes an exterior port pipe to an environment, the second chamber includes an active acoustic radiator, and the third chamber includes an active acoustic radiator. The second and third chambers can each include an auxiliary chamber with an active acoustic radiator.

FIG. 85 schematically illustrates a loudspeaker system with a pressure vessel with three chambers, wherein the first chamber includes two active acoustic radiators, the second chamber includes an exterior port pipe to an environment, and the third chamber includes an exterior port pipe to the environment. The second and third chambers can each include an auxiliary chamber with an active acoustic radiator.

FIG. 86 schematically illustrates a loudspeaker system with a pressure vessel with three chambers, wherein the first chamber includes an active acoustic radiator and a passive acoustic radiator, the second chamber includes an exterior port pipe to an environment, and the third chamber includes an exterior port pipe to the environment. The second and third chambers can each include an auxiliary chamber with an active acoustic radiator.

### DETAILED DESCRIPTION

A loudspeaker can convert electric signals received from an electronic system (e.g., an audio amplifier) to sound waves having nearly the same spectral characteristics as the original sound. A loudspeaker comprises at least one electro-acoustic transducer (referred to as active transducer or speaker driver) and an enclosure on which the speaker driver is mounted. The enclosure enhances the fidelity (e.g., spectral fidelity) of sound produced by the loudspeaker compared to sound produced by the speaker driver in the absence of the enclosure.

Loudspeakers may be beneficially located outside another enclosure, such as a vehicle enclosure. The loudspeaker can include a system that is disposed at least partially within a pressure vessel. The pressure vessel can have one or more acoustic radiators (e.g., active, passive), one or more acoustic channels between the pressure vessel and an interior of the vehicle enclosure, one or more vents, one or more partitions forming various partitions, and/or other elements described herein. The acoustic channels or vents can cause fluid communication between an environment outside the pressure vessel and an interior of the pressure vessel (e.g., one or more chambers thereof).

For such exterior-located loudspeaker systems, it may be desirable to produce acoustic output at low frequencies in a closed or semi-closed vehicle interior simultaneously with the vehicle exterior. It may be beneficial to provide acoustic output over a range of frequencies in a vehicle interior via an accessory air path from an exterior loudspeaker that is simultaneously producing acoustic output outside the vehicle that is in phase with the acoustic output outside the vehicle as is known in the art.

In some embodiments, acoustically resonant systems can increase acoustic output from a speaker enclosure and/or isolate a speaker from exterior conditions. For example, described herein are embodiments that enable production of exterior audio systems efficiently satisfying high output level requirements while simultaneously providing audio transmission to a vehicle interior that is substantially in-phase with the audio transmission to the exterior. Embodiments have been described in the prior art that can produce audio in the vehicle simultaneously with the exterior of the vehicle using a single speaker, but the output into the vehicle interior provided by these systems has been typically out of phase with the acoustic output provided into the vehicle exterior, limiting their application and usefulness, and a method to provide efficient in-phase acoustic radiation into both the vehicle interior and the exterior of the vehicle has been needed in the art.

As described herein, certain configurations may be particularly suited to low frequencies that can accompany an exterior audio system for a vehicle and/or supplement an interior audio system of a vehicle. One or more air pathways, such as acoustic channels, may incorporate features such as varying cross-sectional area along a path length, sound absorbing materials, horns, flares, grilles, semi-permeable membranes, and/or cosmetic transitions between the air path and a flat, curved, or contoured surface. Some air pathways may behave as a resonant acoustic mass, participating in the formation of a tuned acoustic resonance in an air chamber. In some embodiments, a diaphragm of one or more active transducers and/or passive radiators may additionally or alternatively serve as a barrier to water or vapor ingress from an environment outside the vehicle to the interior space of the vehicle and/or to one or more chambers of the pressure vessel, and/or to corrosion-sensitive components of the active transducer (e.g., magnetic circuit). In some embodiments, a semi-permeable membrane, filter, breather, valve, and/or other flow-permitting or flow-resistive element described herein may be provided to prevent water or vapor ingress to the vehicle interior.

A loudspeaker transducer may be referred to as a “speaker” and/or “active transducer”. A loudspeaker can have at least a voice coil motor assembly, a diaphragm, and a resilient suspension for the diaphragm to support motion normal to the plane of mounting. The loudspeaker can be capable of receiving an audio signal and producing antiphase sound pressure between two air volumes through a motion of the diaphragm proportional to the input signal. Additionally or alternatively a loudspeaker transducer can include compound arrangements of transducers, such as “isobaric” pairs and/or multiple transducers mounted on a same wall of an enclosure.

A passive radiator (e.g., “drone cone”, “auxiliary radiator”, “bass diaphragm”) can have at least a diaphragm, a mass element integral or attached to the diaphragm, and a resilient suspension for the diaphragm to support motion normal to the plane of mounting. The diaphragm may move in a translating, bending, deforming, or swinging mode of operation. The diaphragm may be made water-tight or vapor-tight.

A vent can be a port pipe (e.g., “reflex port/vent”) having a tube or conduit that is open at each end. The vent can have a substantially constant cross-sectional area between the two ends and/or a defined length between the two ends defining a suspended mass of air inside. A cross-sectional area of the vent may be round (e.g. cylindrical), obround, elliptical, rectangular (e.g. slotted), triangular, or another geometric shape; such a vent generally cannot provide a water barrier due to being filled with air and open at either end with low resistance to air flow. Vents and passive radiators may be considered to be “acoustic mass” elements used to tune a resonance of an air volume. In some embodiments vents and passive radiators may be implemented interchangeably to achieve the same or similar effect in the loudspeaker systems described herein while preventing the passage of water or corrosive vapor between chambers.

Various embodiments described herein include one or more accessory air paths. As used herein, an accessory air path is used to provide a conduit for sound energy from a chamber of the exterior speaker system into the interior of a vehicle. Its definition does not imply any particular set of length, cross sectional area, or end conditions, although it may be defined in a manner that produces a low resistance sound transmission path from one air volume to another. An accessory air path may be configured as a port pipe if the implementation requires it. An additional passive radiating element or diaphragm may be provided in some embodiments to prevent air or water movement in a continuous flowing manner between the vehicle exterior and the vehicle interior, while permitting sound to be transmitted. In other embodiments, a semi-permeable membrane, breather, or other flow-permitting or flow-resistive element may be employed at either end of the air path, provided that such an element substantially permits sound transmission from one area to another.

Relative sizing of the conduit cross-sectional area to the other acoustic vents of the system can be used to adjust the balance of sound output to the interior or exterior of a vehicle. Additionally or alternatively, other or additional resistive means may be used. The conduit may be rigid or flexible. At the end of the conduit interfacing with the interior of the vehicle, an additional grille may be provided to prevent the ingress of debris. This grille may incorporate a semi-permeable membrane (such as Gore-Tex), foam absorptive medium, and/or a breather assembly that incorporates multiple means to protect the end of the conduit from liquids or debris. The end of the conduit interfacing with the vehicle interior may also be hidden behind other vehicle trim panels to avoid being noticed. As described herein, a semi-permeable membrane may be placed at an entrance to the accessory air path that interfaces with an air chamber of the audio system.

The accessory air path to a vehicle interior can produce acoustic output that is substantially in phase with a loudspeaker's output outside the vehicle. In some embodiments, one or more acoustic channels (e.g., vents, accessory air paths) can produce acoustic output in the cabin that is antiphase to the output produced outside the cabin. Additionally or alternatively, the accessory air path may be configured as a reflex vent that participates in acoustic output into the cabin in a manner in-phase with the reflex vent facing the exterior. In some embodiments, an acoustic channel may be replaced with a passive radiator diaphragm acting through an opening in the vehicle interior.

As used herein, the term “exterior” can include the space outside the interior (e.g., cabin volume) of a vehicle. Loudspeaker systems may be installed outside a sheet metal or trim facing. Additionally or alternatively, they may be mounted in a void space between interior walls of the vehicle (defining the enclosed or semi-enclosed cabin air volume) and the outer wall (e.g., sheet metal) of a vehicle, such as in the space above, behind, or beside a battery, motor, axle, or fuel tank.

Mounting of exterior loudspeakers may be permanent, semi-permanent/removable, or temporary. A breather assembly forming a semi-permeable membrane between the interior and exterior may be configured to become airtight or watertight when exposed to water, and may permit airflow again after drying.

The enclosure of the pressure vessel can prevent sound waves generated by a back surface of the diaphragm of the speaker driver interacting with sound waves generated by the front surface of the diaphragm that may be out of phase with each other and thereby distort or reduce the pressure level of the resulting sound waves. As such an enclosure at least include a baffle (e.g., a front surface on which the speaker driver is mounted), a closed box, a vented box, or the like. Additionally, the enclosure may serve as an acoustic resonator that sustains the sound waves generated by the speaker driver. As such the volume and stiffness of the air mass in the enclosure may directly affect the performance of the loudspeaker. As a resonator, the enclosure may tailor the spectral acoustic power distribution of at least a portion of soundwaves generated by the speaker driver that are radiated via the enclosure. As such, enclosure design and configuration is an integral part of manufacturing loudspeakers with desired performance characteristics.

It may be advantageous for a loudspeaker to produce a full range (e.g., covering low-, mid-, and high-frequency ranges) of audio response. A main challenge in loudspeaker design is maintaining the acoustic power generation and radiation efficiency within a frequency range while improving the performance in another frequency range (e.g., a non-overlapping or partially overlapping frequency range). This can be a challenge particularly in speaker systems that are disposed outside a vehicle enclosure. Other types of loudspeaker systems may be optimized to provide efficient low-frequency output, often to assist other loudspeakers operating in other frequency ranges, from which output may be desired both inside and outside a vehicle. Electrical, electronic, digital, mechanical, or acoustical filters may be provided that optimize the interaction between loudspeaker systems operating in multiple frequency ranges concurrently.

Some loudspeaker systems use ported or vented enclosures or passive radiators (also referred to as passive transducers) to enhance the performance of the corresponding loudspeaker. A vented enclosure may have a vent or an opening tube or tube-like structure connected to the opening to improve low-frequency output, increase efficiency, or reduce the size of an enclosure.

Using a passive radiator for radiating low frequency sound waves out of the enclosure may increase low-frequency efficiency of the loudspeaker while allowing the enclosure to be smaller than a vented loudspeaker with a similar performance. In some applications, a suitably tuned passive radiator may be used to replace or operate in concert with one or more port tubes to create an acoustic tuning frequency, as is commonly known in the art. In such arrangements, it is important to carefully consider the water barrier or vapor barrier requirements of the system, such as required to prevent water ingress into a vehicle interior.

A passive radiator can generally refer to a flexible diaphragm with a mass element, or a speaker structure without the electro-acoustic transducer or magnet assembly. In some cases, a passive radiator may comprise a cone or diaphragm, one or more suspensions (e.g., a spider or a rolling seal at the cone edge commonly referred to as a ‘surround’), and/or a frame. In contrast to a speaker driver, passive radiators do not generally include a voice coil for converting electrical signals to vibrations at the cone or diaphragm. A passive radiator may receive primary sound waves (e.g., sound waves generated by a speaker driver) from one side of the cone and re-radiate secondary sound waves from the opposite side of the cone. A passive radiator system is excited by the sound pressure in the enclosure and can be configured to create the low-frequency sound waves (e.g., bass frequencies). A passive radiator may have an effective area through which sound is radiated out of the enclosure or, in some cases, to a chamber of the enclosure that is acoustically coupled to a main chamber of the enclosure to which the speaker driver is connected. The effective area of the passive radiator may have a circular, oval, elliptical, or a square-like shape. In some cases, the effective area of the passive radiator may comprise other shapes. In some cases, the effective area of the passive radiator comprises the standard Sa rating of the passive radiator. In some examples, the effective area of the passive radiator may comprise an area of (e.g., a projected area) of the cone of the passive radiator. For example, when the radius of the cross-section of the cone at the output plane of the PR is R (including half of the rolling seal or surround), the effective area is □*R².

The frequency response of a passive radiator (PR) may comprise a resonant behavior associated with a resonant frequency of the PR. The resonant frequency of the PR may be determined based at least in part by the mass and or a shape of cone/diaphragm and/or properties of the suspensions. Additionally, the resonant frequency of the PR may be affected by the stiffness of the air in the vicinity of the PR. For example, stiffness of air in an enclosure from which the PR receives the primary sound waves, stiffness of the air outside of the enclosure (that is in contact with an external portion of the passive radiator), or stiffness of air in a chamber of the enclosure to which the PR radiates the secondary sound waves.

The resonant frequency of a PR may tuned by varying its mass (e.g., by adding mass to the cone or diaphragm). Alternatively, the PR may be tuned by varying the stiffness of air in contact with the PR (referred to as “loading” effect”). For example, the resonant frequency of a PR may be down tuned (e.g., reduced) by adding mass to its cone, or increasing the stiffness of air in a chamber to which PR radiates the secondary sound waves and/or from which the PR receives the primary sound waves.

Some of the disclosed systems and methods may use a volume of air enclosed in a chamber configured to load the passive radiator and restrict the air movement in an otherwise conventional enclosure, to overcome this tradeoff, improve the sound pressure levels (SPLs) of the generated low frequency sound waves (often by about +3 dB e.g., from 3 dB to 6 dB, from 6 dB to 9 dB, from 9 dB to 12 dB or any range formed by these values), and thereby increase the low frequency performance of the corresponding loudspeaker. As such, the proposed loudspeaker enclosure designs may provide enhanced acoustic radiation efficiency compared to a similar size loudspeaker without the resonant system both at low and high frequencies. Using these designs a loudspeaker may generate sound with higher SPLs without requiring more input power while maintaining the fidelity of the output sound. The passively assisted loaded acoustic chamber may tune the low frequency to extreme low frequency output without a penalty on the overall acoustic power efficiency, allowing for an active low frequency transducer to be designed for higher efficiency.

In some embodiments, the system can include a boundary, partition, or other divider to protect the loudspeaker assembly from certain environmental conditions (e.g., moisture) that would otherwise damage the transducer, e.g., by causing corrosion on the backside of a transducer where the fragile components such as voice coil or other metal parts are exposed. For example, in some embodiments, a loudspeaker enclosure having two or more compartments or chambers including a tuned arrangement configured to enhance the low-frequency response of the speaker driver and increasing the output power acoustic power and efficiency at low frequencies are disclosed. The arrangement and design of boundaries, chambers, and acoustic loading elements can be carefully considered to provide a desired distribution of sound energy both outside and inside of a vehicle interior when such an acoustic radiation characteristic is desired.

In some embodiments, the loudspeaker enclosure may include a first or primary chamber having a main port or opening. At least one speaker driver or other radiator may be disposed in the first chamber. Additionally or alternatively, the system may include a second chamber that is acoustically coupled to the primary chamber, such as via one or more passive radiators or port tubes. The second chamber and the one or more passive radiators or ports may be configured to allow high efficiency acoustic power transfer from the speaker driver to the second chamber or subsequent chambers (e.g., at low frequencies, such as frequencies lower than 200 Hz) and efficient acoustic power radiation from one or more output ports of the second chamber or subsequent chambers. The second chamber and the passive radiator may be configured to improve the low frequency performance (e.g., acoustic power generation and radiation efficiency), with negligible impact on the acoustic power and spectral properties of an active output (also referred to as fundamental sound waves) directly radiated by the one or more speaker drivers away from the loudspeaker. In some cases, the fundamental sound waves may comprise sound waves having frequencies with high and/or middle frequency ranges. Chambers may be designed or optimized to produce or minimize acoustic loss at high and/or middle frequency ranges as required by the application.

The speaker driver may be mounted to a wall (e.g., a front wall) of the primary chamber such that a front face of the speaker driver is external to the primary chamber and a rear face of the speaker driver is internal to the primary chamber. Chamber walls are ideally designed to minimize flexure of the portions of the enclosure where acoustic radiation from the enclosure structure is specifically unwanted. Within any air pathway formed by the enclosure walls or additional tubing, any cross section of the tubing may ideally be made large enough to avoid air rush noise, which is typically unwanted.

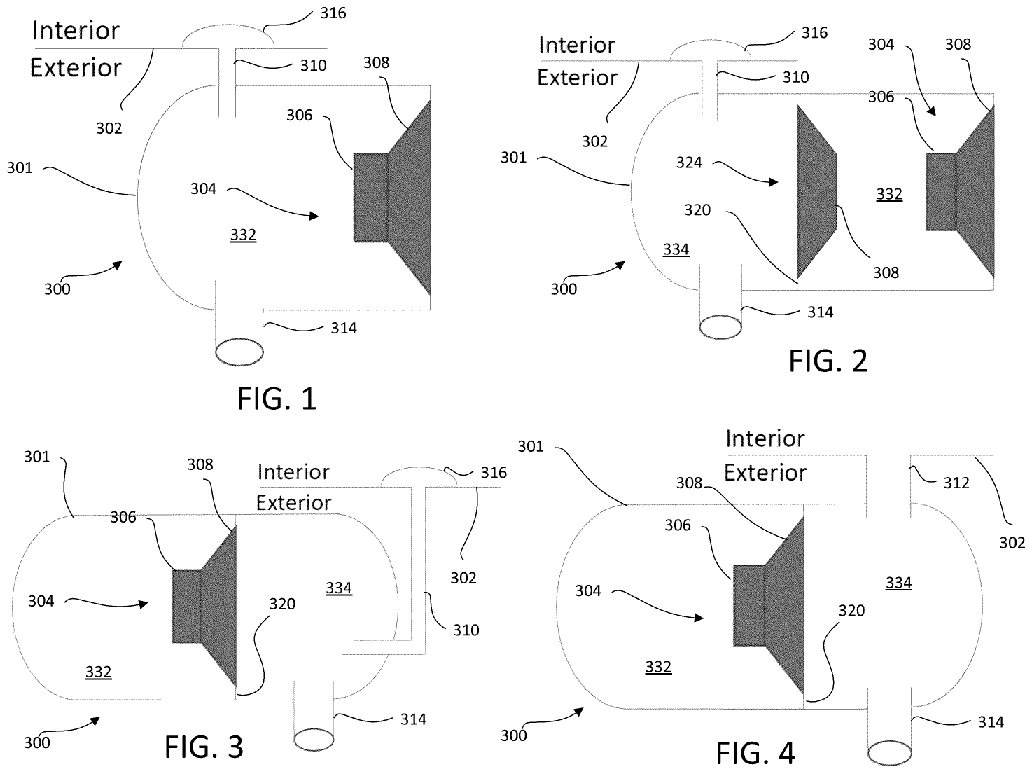

FIGS. 1-9 show schematic diagrams of example loudspeaker systems comprising pressure vessels having one or more chambers, according to various embodiments of the present invention. In the interest of clarity, numbered elements of same or similar function are not repeatedly included in every Figure. Instead, clarity of the Figures has been prioritized where elements having the same or similar function of other elements previously numbered are illustrated. Features of those elements can have one or more of previously described features. Accordingly, not every Figure will be described in detail here. Instead, in the interest of clarity and economy of space, the features of those Figures that are described with more detail can be accorded to the Figures with little or no written description.

Described herein are various pressure vessels disposed outside a vehicle enclosure. The pressure vessels may include one or more acoustic radiators, acoustic channels, acoustic vents, partitions, resistive elements, and/or other features described herein. These features may be disposed within one or more of one or more chambers of a pressure vessel. An acoustic channel can include one or more accessory air paths and/or port pipes. A vent can include a port pipe or other resonant tuning means typical of a vented box system (also known as a bass-reflex system or a ported-box system), and may be replaced by a passive radiating element of suitable tuning where a solid barrier between multiple air volumes is necessary. A vent or passive radiator can be configured to form a target resonant tuning frequency or set of frequencies. For example, it may be valuable for the vehicle to generate a particular sound (e.g., at a particular frequency) for which the system may be tuned to operate most efficiently.

For example, as shown in FIG. 1, a loudspeaker system 300 can include a pressure vessel 301 that has a first chamber 332. The pressure vessel 301 can include an active acoustic radiator 304 disposed within the first chamber 332. The pressure vessel 301 can include an accessory air path 310 that connects the first chamber 332 with an interior of a vehicle enclosure 302. The pressure vessel 301 can include an exterior port pipe 314 that fluidly connects the first chamber 332 with an environment outside the pressure vessel 301. The active acoustic radiator 304 can include a magnetic circuit 306 and a moveable diaphragm 308. The moveable diaphragm 308 may be disposed such that a substantial portion of the moveable diaphragm 308 forms and/or is connected to an exterior of the pressure vessel 301. In some embodiments, the pressure vessel 301 includes a particulate barrier 316. The particulate barrier 316 may be disposed at or near an end of the accessory air path 310 such that particulate matter or liquid mist is prevented from passing between the interior of the vehicle enclosure 302 and the first chamber 332. The end of the accessory air path 310 can be ideally located above the water fording line of the vehicle, but may be positioned below the water fording line of the vehicle if suitable means is provided to prevent water ingress when submerged, such as when a semi-permeable membrane is made wet. Ideally, the example loudspeaker system is comprised of materials which are waterproof or water-resistant, and able to withstand immersion in a body of water or saltwater to a predetermined depth, but some arrangements disclosed later may provide protection for a loudspeaker component without this intrinsic water-resistant characteristic. If an automatic valve is used to prevent water ingress, it should not interfere with the air pressure in either flow direction in the conduit.

FIG. 2 shows another example loudspeaker system 300 with a pressure vessel 301. The pressure vessel 301 can have a partition 320 that forms the first chamber 332 and a second chamber 334. The active acoustic radiator 304 can be disposed within the first chamber 332. The pressure vessel 301 can additionally or alternatively include a passive acoustic radiator 324. The passive acoustic radiator 324 can be in the pressure vessel 301. The passive acoustic radiator 324 can be disposed within the second chamber 334 and/or the first chamber 334. The passive acoustic radiator 324 can be disposed at the partition 320 between the first chamber 332 and the second chamber 334. The passive acoustic radiator 324 can form at least a portion of the partition 320 and/or be connected to the partition 320. The passive acoustic radiator 324 can include a second moveable diaphragm 308, which can be disposed in the pressure vessel 301.

The partition 320 and/or passive acoustic radiator 324 (e.g., diaphragm 308) can form a fluid barrier between the first chamber 332 and the second chamber 334 if the materials of the passive radiator are made water-resistant and water-tight. The fluid barrier can prevent fluid flow between the first chamber 332 and the second chamber 334, in order to protect the rear side of the loudspeaker from direct water or mist exposure. The passive acoustic radiator 324 can be configured to radiate antiphase or resonant acoustic emissions into the first chamber 332 of the pressure vessel 301. The antiphase acoustic emissions can have an opposite phase with and/or substantially similar amplitude of the acoustic emissions radiated by the reverse side of the active acoustic radiator into the first chamber 332, in order to provide a suitable phase-inversion effect near the tuned resonance frequency to provide acoustic transmission from the port pipe and accessory acoustic channel which is in-phase with the exterior sound radiation from the active acoustic radiator.

The accessory air path 310 can connect the second chamber 334 with the interior of the vehicle enclosure 302. The exterior port pipe 314 can connect the second chamber 334 with the environment outside both the pressure vessel 301 and the vehicle enclosure 302. The exterior port pipe 314 can be configured to form an acoustic bandpass filter from the second chamber 334 to the environment.

In some variants, an acoustic channel configured as a port pipe (e.g., an interior port pipe) can be configured to form an acoustic bandpass filter from the second chamber 334 to the interior of the vehicle enclosure 302. In some embodiments, the loudspeaker system 300 can include a second exterior port pipe connecting the first chamber 332 with the environment outside both the pressure vessel 301 and the vehicle enclosure 302. The second exterior port pipe can be configured to form an acoustic bandpass filter from the first chamber 332 to the environment outside both the pressure vessel 301 and the vehicle enclosure 302.

In some embodiments, the passive acoustic radiator 324 can be configured to form a first resonant tuning frequency. In some embodiments, the exterior port pipe 314 can include a vent. The vent may be configured to form a second resonant tuning frequency. The second resonant tuning frequency may be different from the first resonant tuning frequency in some embodiments.

FIG. 3 shows an example loudspeaker system 300 having a pressure vessel 301 with a first chamber 332 and a second chamber 334. The active acoustic radiator 304 can be disposed in the first chamber 332. The active acoustic radiator 304 can be disposed at the partition 320 between the first chamber 332 and the second chamber 334, which can include the active acoustic radiator 304 forming at least a portion of the partition 320 and/or being connected to the partition 320. The moveable diaphragm 308 can be disposed such that a substantial portion of the moveable diaphragm 308 forms and/or is connected to the partition 320. The magnetic circuit 306 and/or moveable diaphragm 308 of the active acoustic radiator 304 can be disposed in the first chamber 332 for protection from the exterior environment of the vehicle, or may be oriented with the magnetic circuit facing the opposite chamber if the application requires it, without substantially modifying the acoustic output of the system apart from having reversed mechanical polarity of the diaphragm movement, which can be compensated electrically. The moveable diaphragm 308 can be configured to transmit acoustic emissions into the second chamber 334, with the antiphase radiation from the opposite side of the movable diaphragm being transmitted into the first chamber 332. The pressure vessel 301 can include an accessory air path 310 that connects the interior of the vehicle enclosure 302 with the second chamber 334. The loudspeaker system 300 can include an exterior port pipe 314 that can connect the second chamber 334 to the environment outside the pressure vessel 301. In this configuration, the primary source of acoustic radiation outside the vehicle is from the port pipe, while the primary source of acoustic radiation inside the vehicle is from the interior end of the accessory air path. This may be advantageous in some applications to provide an exit for acoustic radiation that has similar cosmetic appearance to a vehicle tailpipe. Any port pipe in the disclosed systems according to the present invention may be replaced by a plurality of port pipes connecting the same two air volumes, or a plurality of passive radiators connecting the same two air volumes; the behavior of such a system is to form a single effective tuned frequency, despite the plurality of resonant acoustic mass elements. Similarly, the accessory air path may be replaced by a plurality of accessory air paths having similar or different routing to parts of the vehicle interior.

FIG. 4 shows a loudspeaker system 300 with an accessory air path configured as an interior-facing port pipe 312 that connects the second chamber 334 to the interior of the vehicle enclosure 302. In some variants, the interior port pipe 312 can be configured to form an acoustic bandpass filter from the second chamber 334 to an interior of the vehicle enclosure 302. The loudspeaker system 300 can include an exterior port pipe 314 that connects the second chamber 334 with the environment outside both the pressure vessel 301 and the vehicle enclosure 302. In some variants, the exterior port pipe 314 can be configured to form an acoustic bandpass filter from the second chamber 334 to the environment outside both the pressure vessel 301 and the vehicle enclosure 302. If the accessory air path is configured as an interior-facing port pipe, it may be important for the entry location of the port pipe into the vehicle interior to be above the water fording line of the vehicle.

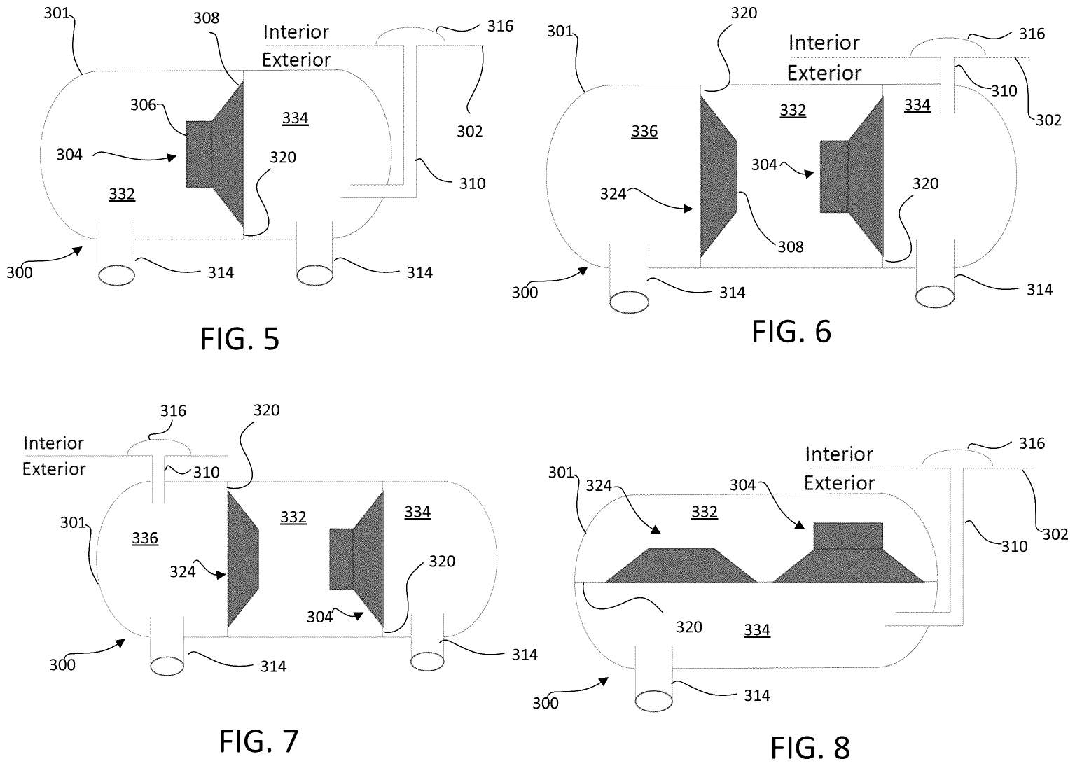

FIG. 5 shows an example loudspeaker system 300 with two exterior port pipes 314. A first exterior port pipe 314 connects the first chamber 332 with the environment outside both the pressure vessel 301 and the vehicle enclosure 302. A second exterior port pipe 314 connects the second chamber 334 with the environment outside both the pressure vessel 301 and the vehicle enclosure 302. An accessory air path 310 can connect the second chamber 334 with an interior of the vehicle enclosure 302. This type of system may form a ‘dual tuned’ acoustic bandpass filter arrangement between the two chambers and the exterior of the vehicle.

FIG. 6 shows an example loudspeaker system 300 having two partitions 320 that separate the first chamber 332, second chamber 334, and third chamber 336. As shown, a passive acoustic radiator 324 and an active acoustic radiator 304 can each be disposed within the first chamber 332. The moveable diaphragm 308 of the passive acoustic radiator 324 can be configured to transmit acoustic emissions into the third chamber 336. Additionally or alternatively, the active acoustic radiator 304 can be configured to drive acoustic emissions into the second chamber 334. A first exterior port pipe 314 can connect the third chamber 336 with the environment. A second exterior port pipe 314 can connect the second chamber 334 with the environment. An accessory air path 310 can connect the second chamber 334 with the interior of the vehicle enclosure 302. This type of system may form a ‘series-tuned’ acoustic bandpass filter arrangement between the three chambers and the exterior of the vehicle. Additionally, the passive radiator may provide a protective water barrier between the port tube of chamber 336 and the back side of the active acoustic radiator.

The passive acoustic radiator 324 can form at least a portion of the second partition 320 and/or be connected to the second partition 320. An accessory air path 310 can be configured to fluidly connect the second chamber 334 and/or third chamber 336 with the interior of the vehicle enclosure 302. As shown herein, various embodiments include one or more accessory air paths 310 that can connect one or more of the first chamber 332, the second chamber 334, the third chamber 336, and/or a fourth chamber 338. Additional chambers and/or accessory air paths can be included.

In some embodiments, the loudspeaker system 300 can have a second exterior port pipe 314 connecting the third chamber 336 with the environment outside both the pressure vessel 301 and the vehicle enclosure 302. As shown in various embodiments herein, additional exterior port pipes 314 may be included. FIG. 7 shows an example loudspeaker system 300 with the accessory air path 310 connecting the third chamber 336 with the interior of the interior port pipe 312. The additional port pipes may form additional resonant tuning frequencies between the chambers and the surrounding environment outside/inside the vehicle.

FIG. 8 shows an example loudspeaker system 300 with both an active acoustic radiator 304 and a passive acoustic radiator 324 disposed such that the corresponding moveable diaphragms 308 of each are both connected to and/or forming a part of the same partition 320. The partition 320 can separate the first chamber 332 and second chamber 334. An exterior port pipe 314 can connect the second chamber 334 with the environment. An accessory air path 310 can connect the second chamber 334 with an interior of the vehicle enclosure 302.

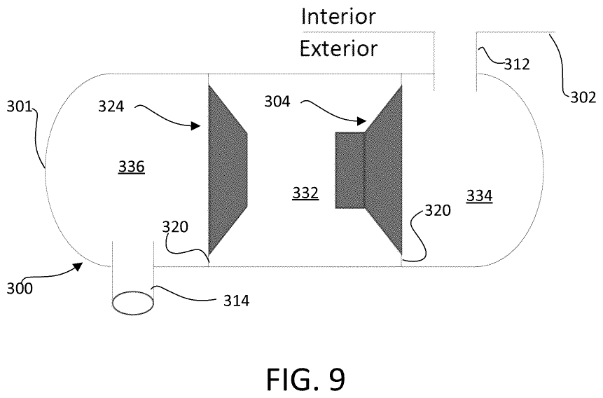

FIG. 9 shows an example of a loudspeaker system 300 having three chambers. The active acoustic radiator 304 and the passive acoustic radiator 324 are both disposed within the first chamber 332, an interior port pipe 312 connects the second chamber 334 with the interior of the vehicle enclosure 302, and/or the exterior port pipe 314 connects the environment with the third chamber 336. The moveable diaphragm 308 of the passive acoustic radiator 324 can be configured to transmit acoustic emissions into the third chamber 336. Additionally or alternatively, the active acoustic radiator 304 can be configured to drive acoustic emissions into the second chamber 334. FIGS. 9 and 50 demonstrate that either the active or the passive acoustic radiator may be vented directly into the vehicle cabin as required by a particular application.

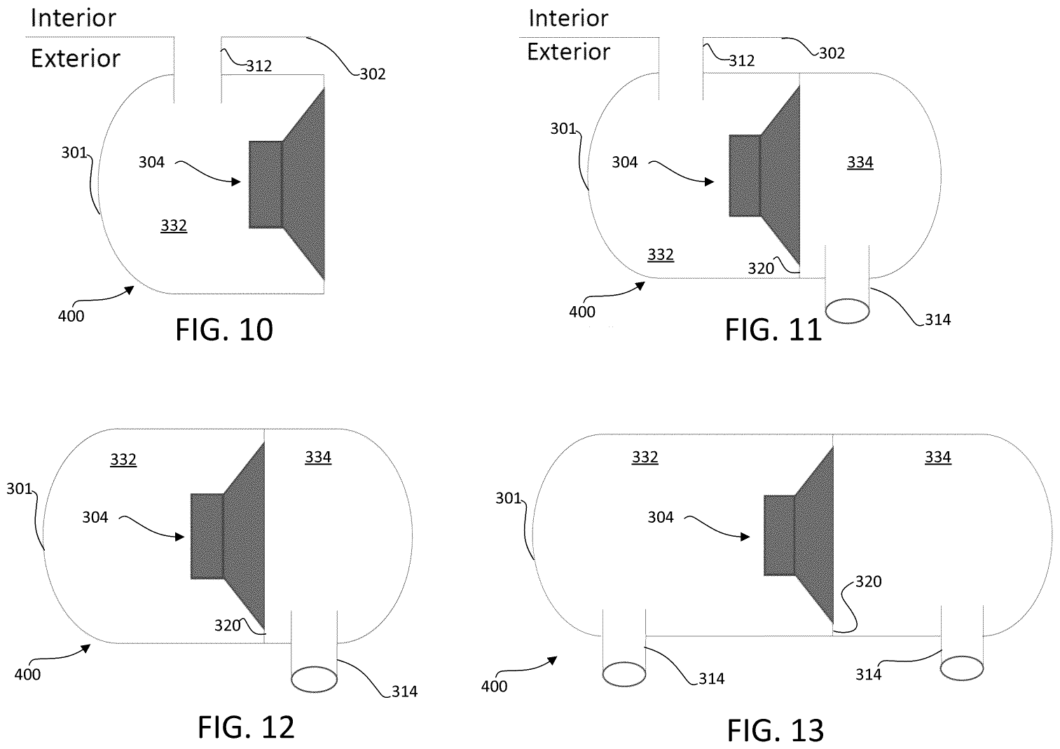

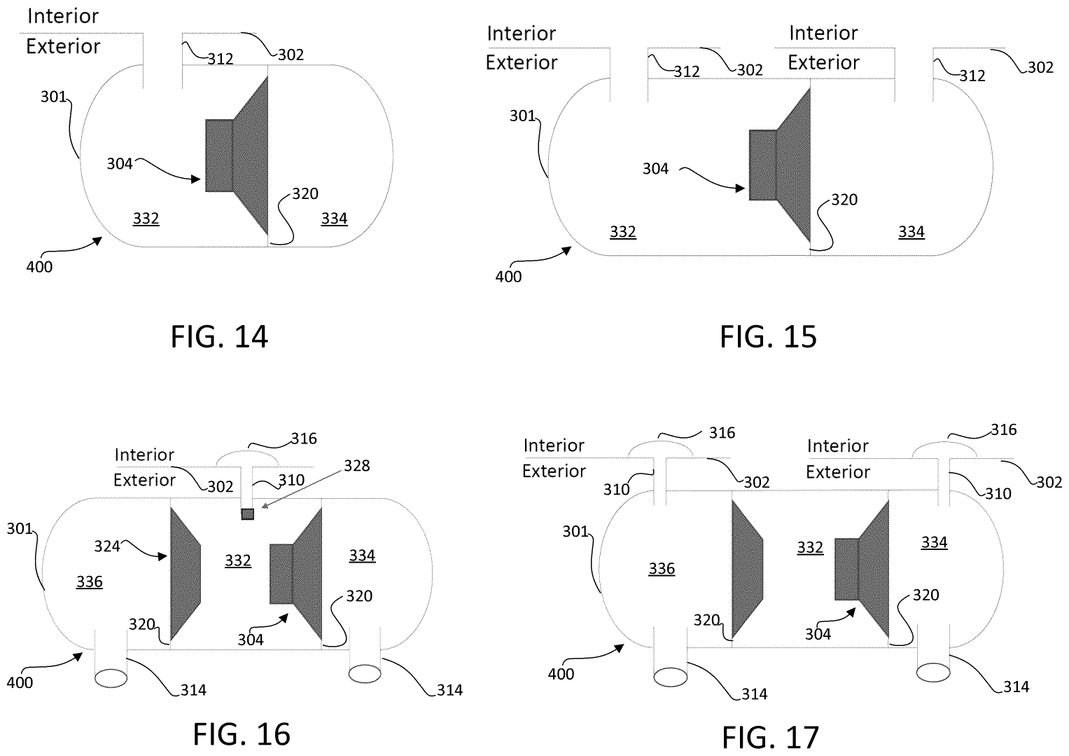

FIGS. 10-15 show schematic diagrams of example prior art loudspeaker systems 400 with pressure vessels 301 having one or more active acoustic radiators 304. For example, FIG. 10 illustrates a system according to the prior art with a first chamber 332 with an active acoustic radiator 304. The loudspeaker system 400 can include an interior port pipe 312 connecting the first chamber 332 with an interior of the vehicle enclosure 302. FIG. 11 illustrates another loudspeaker system 400 according to the prior art with a second chamber 334 with an exterior port pipe 314 connecting the second chamber 334 with the environment. FIG. 12 illustrates the loudspeaker system 400 without an interior port pipe 312 connecting the interior of the vehicle enclosure 302 with the first chamber 332, forming a previously well-known 4^{th}-order acoustic bandpass system. FIG. 13 illustrates the loudspeaker system 400 with exterior port pipes 314 connecting the first chamber 332 and the second chamber 334 with the environment, forming a previously well-known dual-tuned or 6^{th}-order acoustic bandpass system. FIG. 14 illustrates the loudspeaker system 400 without an exterior port pipe 314 connecting the second chamber 334 to an environment, forming a 4^{th}-order acoustic bandpass system whose output is directed into a vehicle interior in a ‘blow through’ application. FIG. 15 shows an example loudspeaker system 400 having a plurality of interior-facing port pipes 312. One interior port pipe 312 can connect the first chamber 332 to the interior of the vehicle enclosure 302 and another interior port pipe 312 can connect the second chamber 334 to the interior of the vehicle enclosure 302, forming a dual-tuned or 6^{th}-order acoustic bandpass system whose output is directed into a vehicle interior; such systems have been known to be previously employed, and are presented here to differentiate them from the present invention.

FIG. 16 shows an example loudspeaker system with accessory air path 310 having a resistive element 328 disposed therein. The resistive element 328 can be a flow-resistant element that reduces the flow of air or acoustic emissions therethrough. Accordingly, the resistive element 328 can also function as an acoustic mass element. The resistive element 328 can be configured to serve as a filter of sounds passing from one or more chambers of the pressure vessel 301 and an interior of the vehicle enclosure 302, particularly from those chambers experiencing high internal sound pressures. For example, as shown in FIG. 16, the resistive element 328 can serve as a sound filter between the first chamber 332 and the interior of the vehicle enclosure 302.

FIG. 17 shows an example loudspeaker system 300 having a plurality of accessory air paths 310 and a plurality of exterior port pipes 314 in a new configuration beyond those previously known to the art. For example, an accessory air path 310 can connect the interior of the vehicle enclosure 302 to the third chamber 336 and another accessory air path 310 can connect the interior of the vehicle enclosure 302 to the second chamber 334. Particulate barrier 316 can be disposed over the openings of the accessory air paths 310 into the interior of the vehicle enclosure 302. An exterior port pipe 314 can connect the second chamber 334 to the environment and another exterior port pipe 314 can connect the third chamber 336 to the environment.

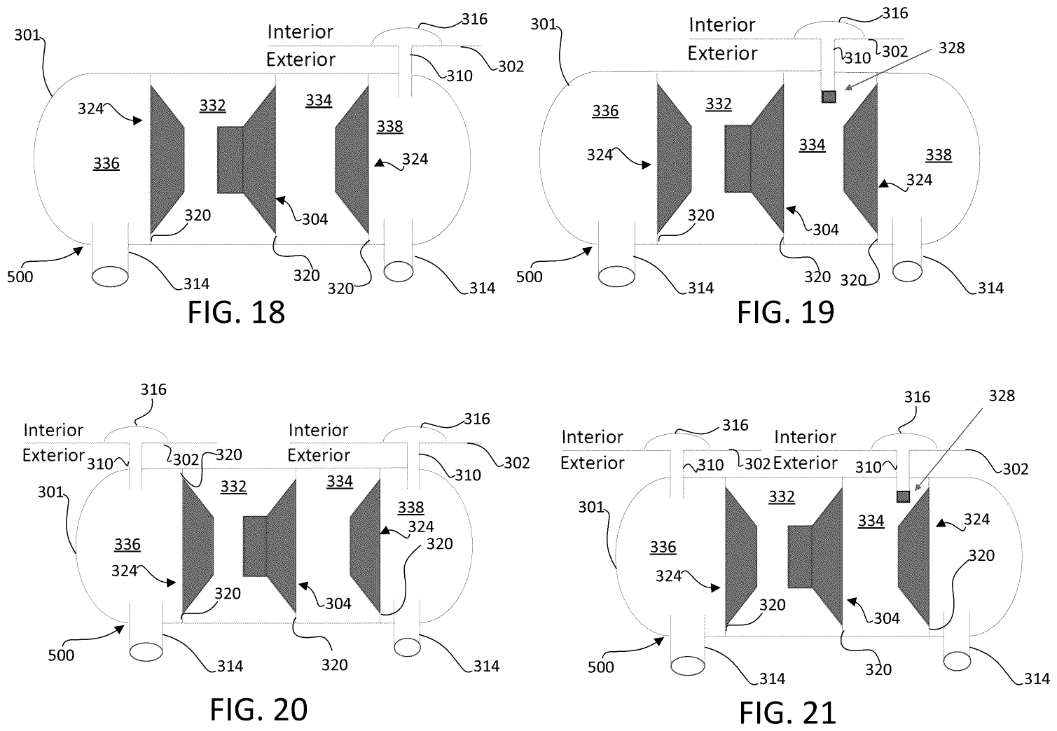

FIGS. 18-32 show schematic diagrams of example loudspeaker systems 500 with pressure vessels 301 having one or more accessory air paths 310 to an interior of a vehicle enclosure 302, according to various embodiments. Various embodiments shown in FIGS. 18-32 include two, three, or more active acoustic radiators 304 and/or passive acoustic radiators 324. FIG. 18 shows a loudspeaker system 500 with a pressure vessel 301 having four chambers-a first chamber 332, second chamber 334, third chamber 336, and fourth chamber 338. The first chamber 332 can include an active acoustic radiator 304 and passive acoustic radiator 324. The second chamber 334 can include a passive acoustic radiator 324. The third chamber 336 can include an exterior port pipe 314 to an environment. The fourth chamber 338 can include an exterior port pipe 314 to the environment. The fourth chamber 338 can include an accessory air path 310 to an interior of a vehicle enclosure 302, which can include a particulate barrier 316. FIG. 19 illustrates the accessory air path 310 to the second chamber 334 and with a resistive element 328 as described herein. FIG. 20 illustrates the second chamber 334 with accessory air paths 310 from the interior of the vehicle enclosure 302 to the third chamber 336 and the fourth chamber 338. FIG. 21 illustrates accessory air paths 310 to the second chamber 334 and the third chamber 336 with the accessory air path 310 to the second chamber 334 including the resistive element 328.

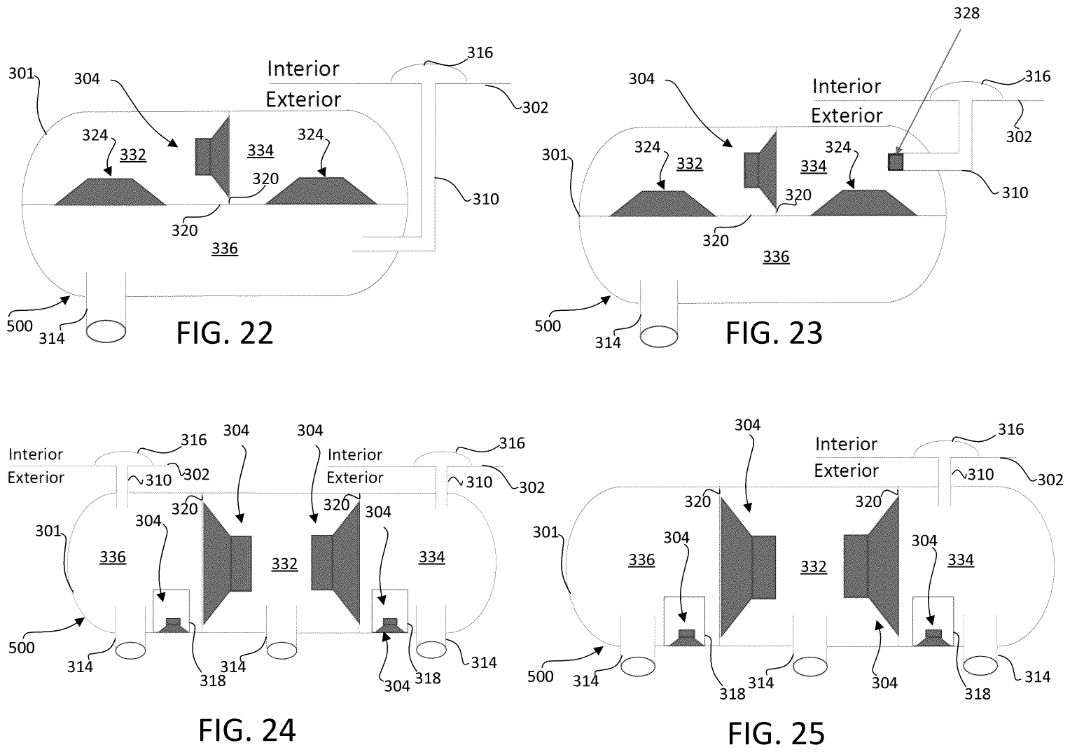

FIG. 22 illustrates a loudspeaker system 500 with a pressure vessel 301 having three chambers. The first chamber 332 can include an active acoustic radiator 304 and a passive acoustic radiator 324. The second chamber 334 can include a passive acoustic radiator 324. The third chamber 336 can include an accessory air path 310 and/or exterior port pipe 314. As illustrated in FIG. 23, the accessory air path 310 can connect to the second chamber 334 and/or include a resistive element 328.

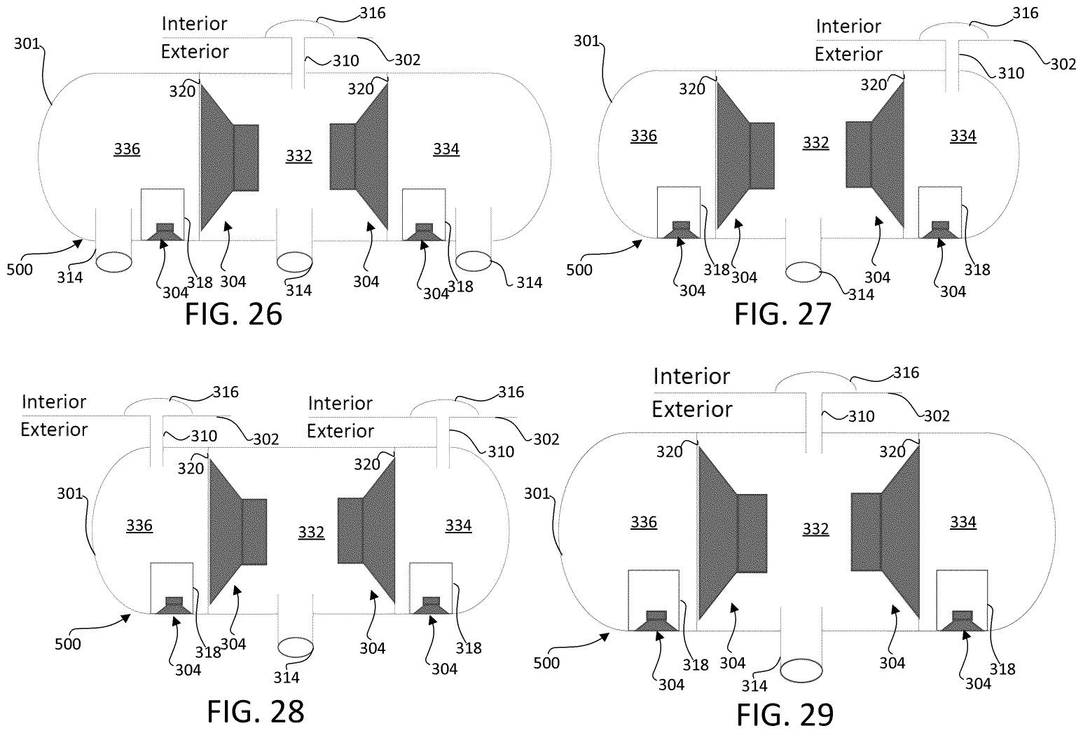

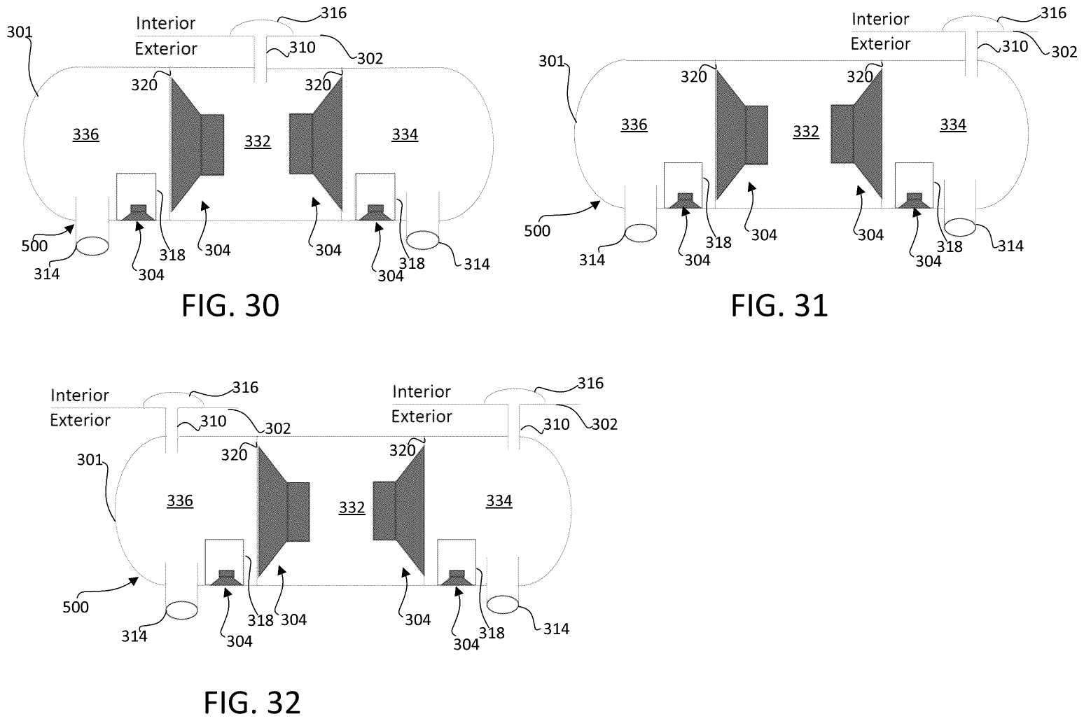

The loudspeaker systems 500 can include an active acoustic radiators 304 to direct (e.g., generate, transmit) acoustic emissions directly into the environment outside the pressure vessel 301. For example, FIG. 24 shows an example embodiment with two active acoustic radiators 304 configured to generate acoustic emissions into corresponding chambers of the pressure vessel 301. Such a configuration can be advantageous to provide cancellation of lateral forces imparted to the enclosure, to reduce unwanted vibration, or to provide a symmetrical configuration to suit a range of cosmetic designs. FIG. 24 shows a pressure vessel 301 with three chambers. The first chamber 332 can include two active acoustic radiators 304 and/or an exterior port pipe 314. The second chamber 334 can include an accessory air path 310 and/or an exterior port pipe 314. The third chamber 336 can include an accessory air path 310 and/or an exterior port pipe 314. The loudspeaker system 500 can include active acoustic radiator 304 configured to generate and direct acoustic emissions directly into the environment. For example, two active acoustic radiators 304 can be configured such that the corresponding diaphragms are attached to and/or form a part of wall of the pressure vessel 301. The second chamber 334 and/or the third chamber 336 can each include auxiliary chambers 318 with active acoustic radiators 304 configured as described, operating in an overlapping or separate frequency range from the enclosed system, permitting a wide operating bandwidth for the complete unitary system while protecting the auxiliary active radiators from damage by low frequency pressure in the other chambers. FIG. 25 shows that the accessory air path 310 to the third chamber 336 can be omitted, and the system need not be symmetrical. FIG. 26 shows an accessory air path 310 connecting to the first chamber 332 and exterior port pipes 314 connecting to the first chamber 332, second chamber 334, and third chamber 336. FIG. 27 shows omitting the exterior port pipes 314 connecting to the second chamber 334 and third chamber 336 and an accessory air path 310 connecting to the second chamber 334. FIG. 28 illustrates the accessory air paths 310 connecting to the second chamber 334 and third chamber 336 and an exterior port pipe 314 connecting to the first chamber 332. FIG. 29 shows the accessory air path 310 and the exterior port pipe 314 connecting to the first chamber 332. FIG. 30 shows the accessory air path 310 connecting to the first chamber 332 and the exterior port pipes 314 connecting to the second chamber 334 and third chamber 336. FIG. 31 shows the accessory air path 310 connecting to the second chamber 334. FIG. 32 shows the accessory air paths 310 connecting to the second chamber 334 and third chamber 336.

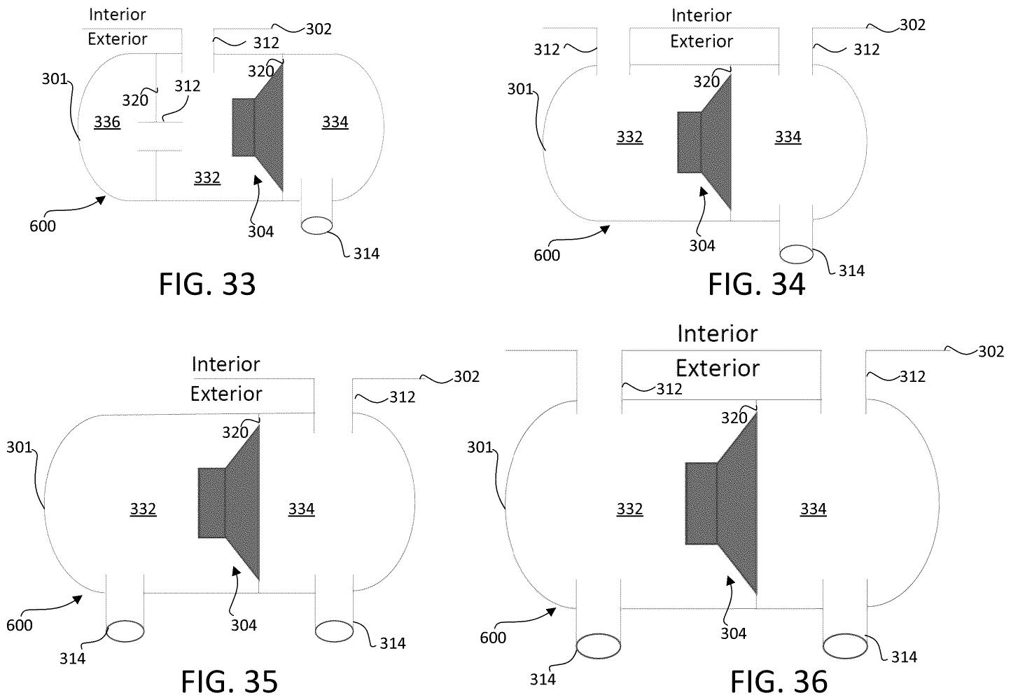

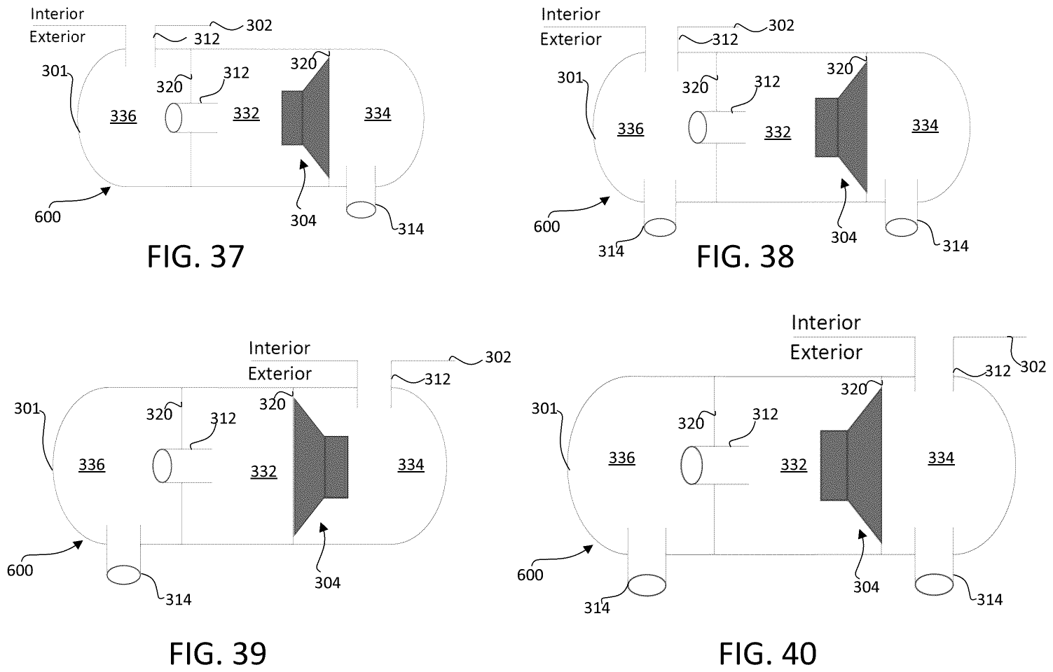

FIGS. 33-81 show schematic diagrams of example loudspeaker systems 600 with pressure vessels 301 having one or more tuning ports to an interior of a vehicle enclosure, according to various embodiments. Other tuning ports may be included additionally or alternatively to create acoustic tuning frequencies or other fluid communication between chambers. FIG. 33 illustrates a loudspeaker system 600 with three chambers. The first chamber 332 includes an active acoustic radiator 304 and an interior port pipe 312 to the interior of the vehicle enclosure 302. The second chamber 334 includes an exterior port pipe 314. An interior port pipe 312 is included that connects the first chamber 332 and a third chamber 336, which may function as an integral acoustic absorber at a tuned frequency. The interior port pipe 312 may include one or more features of any other interior port pipe 312 described herein such as those shown in FIG. 37.

FIG. 34 illustrates a loudspeaker system 600 with two chambers. The first chamber 332 includes an active acoustic radiator 304. The second chamber 334 includes an exterior port pipe 314. Interior port pipes 312 can connect the first chamber 332 and the second chamber 334 to the interior of the vehicle enclosure 302. FIG. 35 illustrates that the first chamber 332 can omit the interior port pipe 312 and include an exterior port pipe 314. FIG. 36 illustrates that the first chamber 332 can include both the interior port pipe 312 and the exterior port pipe 314.

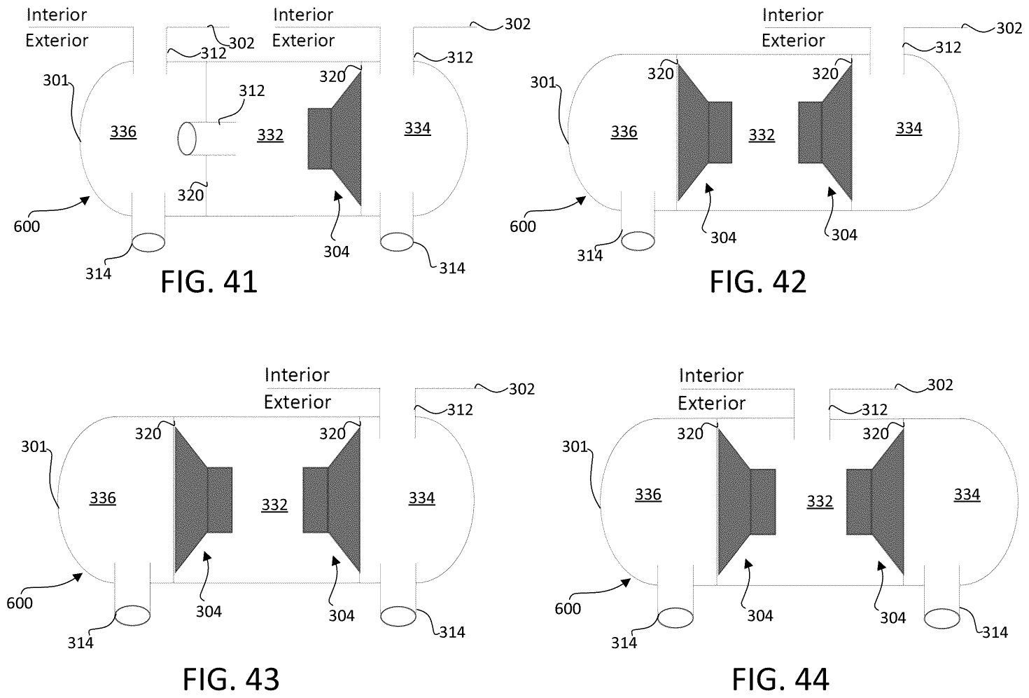

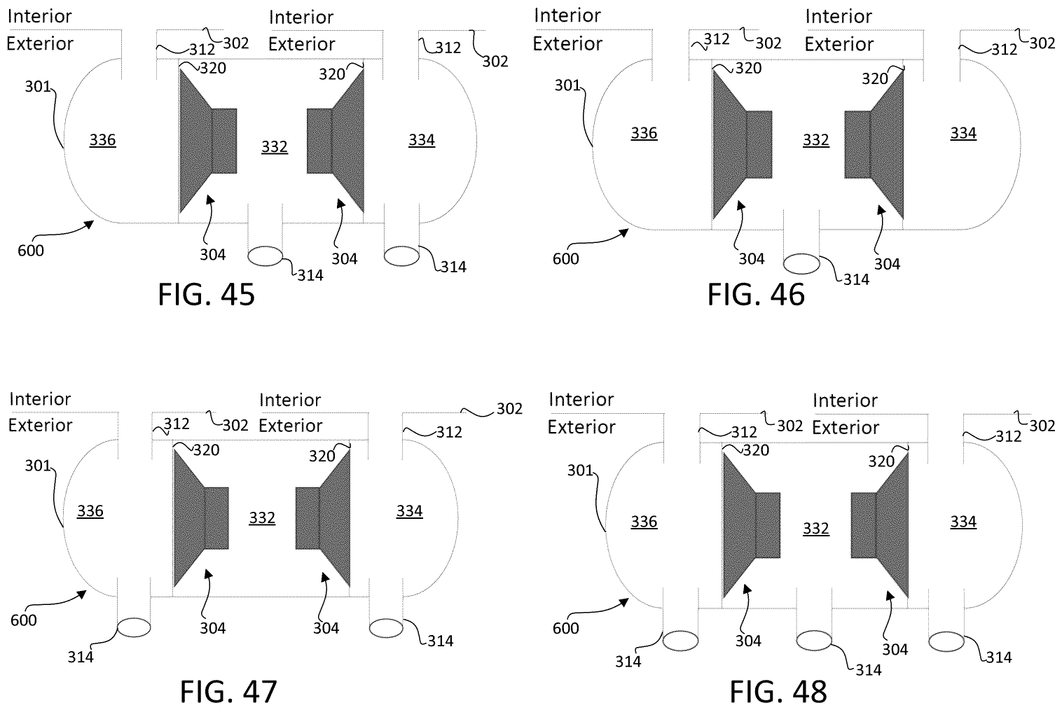

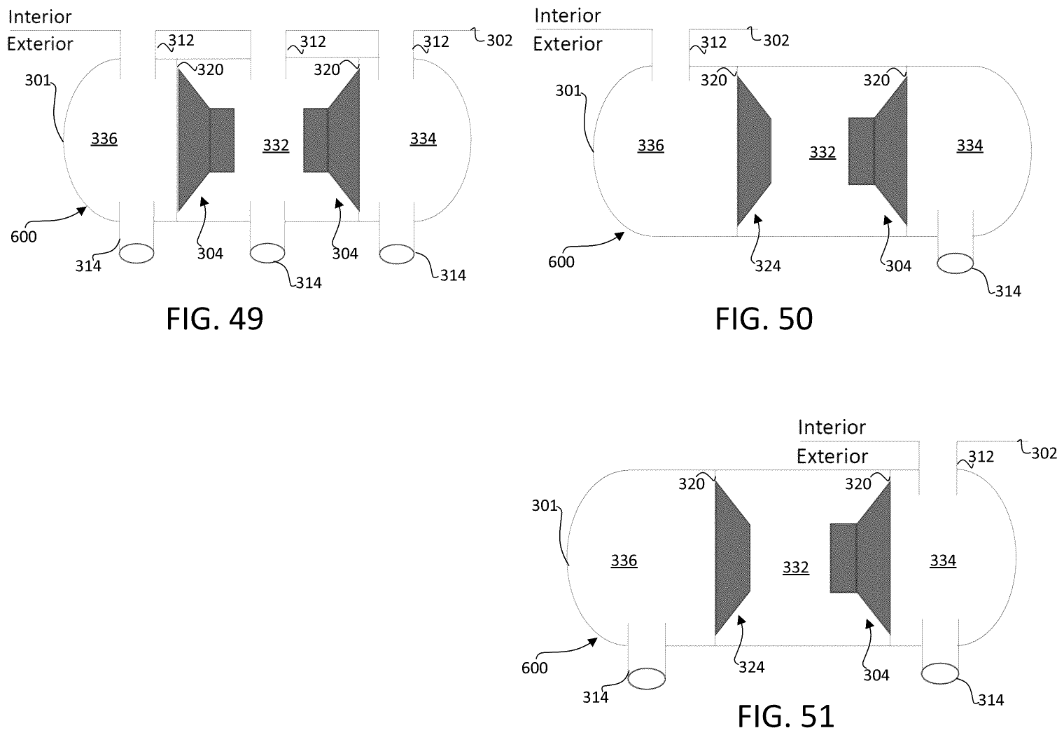

FIG. 38 illustrates a loudspeaker system 600 with three chambers, demonstrating series tuning of the chambers. The first chamber 332 can include an active acoustic radiator 304. The second chamber 334 can include an exterior port pipe 314. The third chamber 336 can include an interior port pipe 312 and an exterior port pipe 314. An interior port pipe 312 can connect the first chamber 332 and the third chamber 336. FIG. 39 illustrates that an interior port pipe 312 can connect to the second chamber 334 instead of the third chamber 336, the exterior port pipe 314 to the second chamber 334 can be omitted, and the active acoustic radiator 304 can be disposed in the second chamber 334. FIG. 40 illustrates that the first chamber 332 can be in the first chamber 332 and an exterior port pipe 314 can connect to the second chamber 334. FIG. 41 illustrates that an interior port pipe 312 can connect to the third chamber 336. FIG. 42 illustrates that the interior port pipe 312 can be omitted and the two active acoustic radiator 304 can be disposed in the first chamber 332. An interior port pipe 312 can connect to the second chamber 334. An exterior port pipe 314 can connect to the third chamber 336. FIG. 43 illustrates that exterior port pipes 314 can connect to the second chamber 334 and third chamber 336. An interior port pipe 312 can connect to the second chamber 334. FIG. 44 shows that the interior port pipe 312 can connect to the first chamber 332. FIG. 45 illustrate that interior port pipes 312 can connect to the second chamber 334 and the third chamber 336 and that the exterior port pipe 314 can connect to the first chamber 332 and second chamber 334. FIG. 46 illustrates that interior port pipes 312 can connect to the second chamber 334 and the third chamber 336 and an exterior port pipe 314 can connect to the first chamber 332. FIG. 47 illustrates that interior port pipes 312 and exterior port pipes 314 can connect to the second chamber 334 and third chamber 336. FIG. 48 illustrates that an exterior port pipe 314 can also be connected to the first chamber 332. FIG. 49 illustrates that interior port pipes 312 and exterior port pipe 314 can be connected to each of the first chamber 332, second chamber 334, and/or third chamber 336. As amply depicted, a plurality of vent/chamber networks are possible to establish a desired set of series/parallel tuning of chambers and routing of the chamber output to the interior or exterior of a vehicle, and this can have a benefit in defining a system with efficient output over a wide frequency bandwidth.

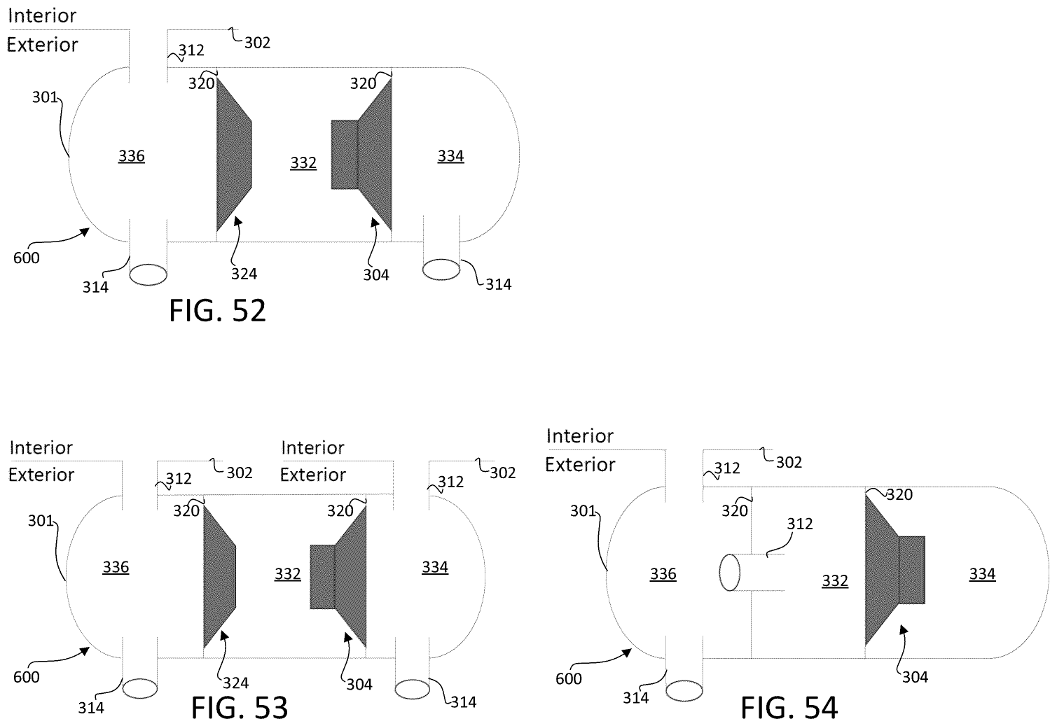

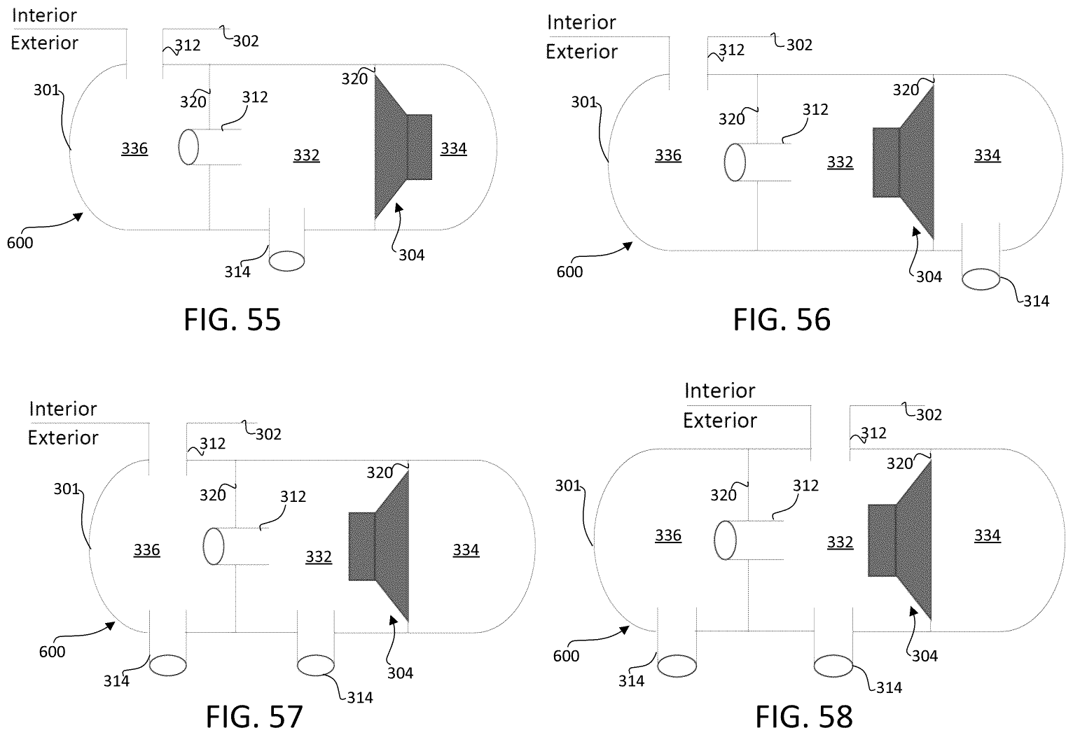

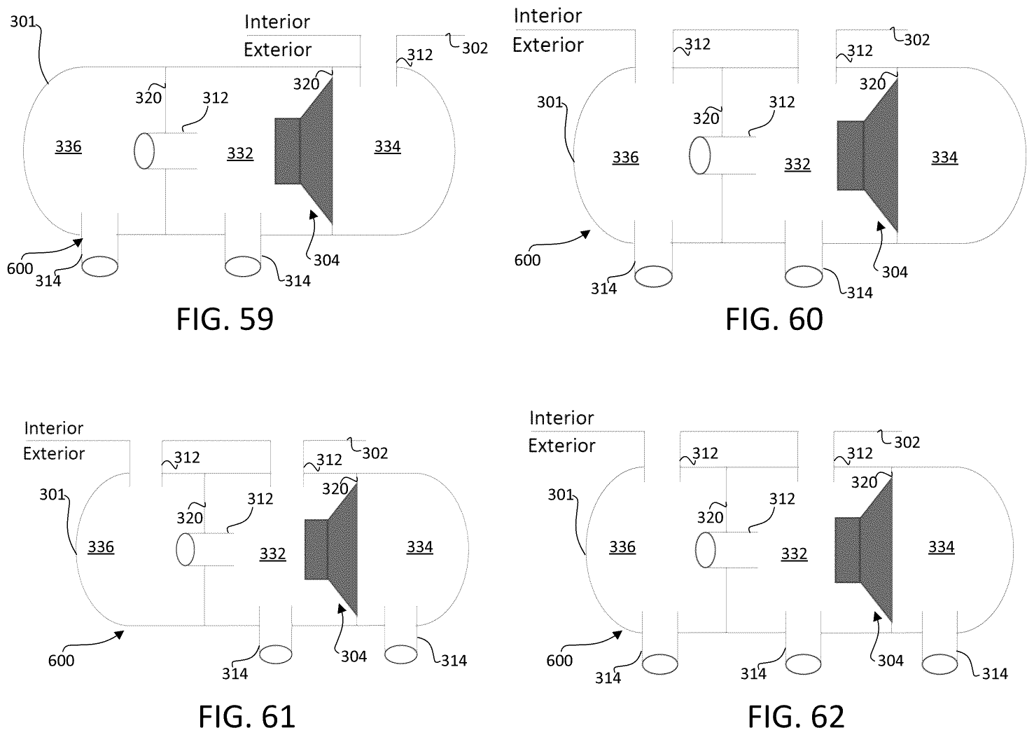

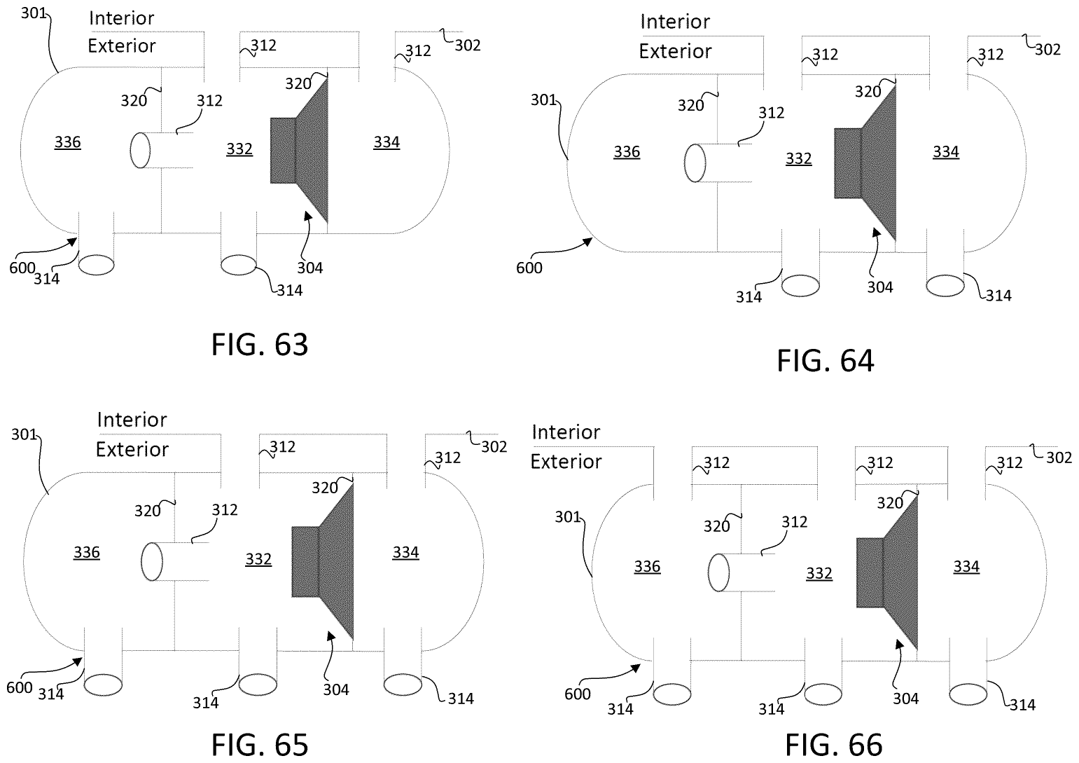

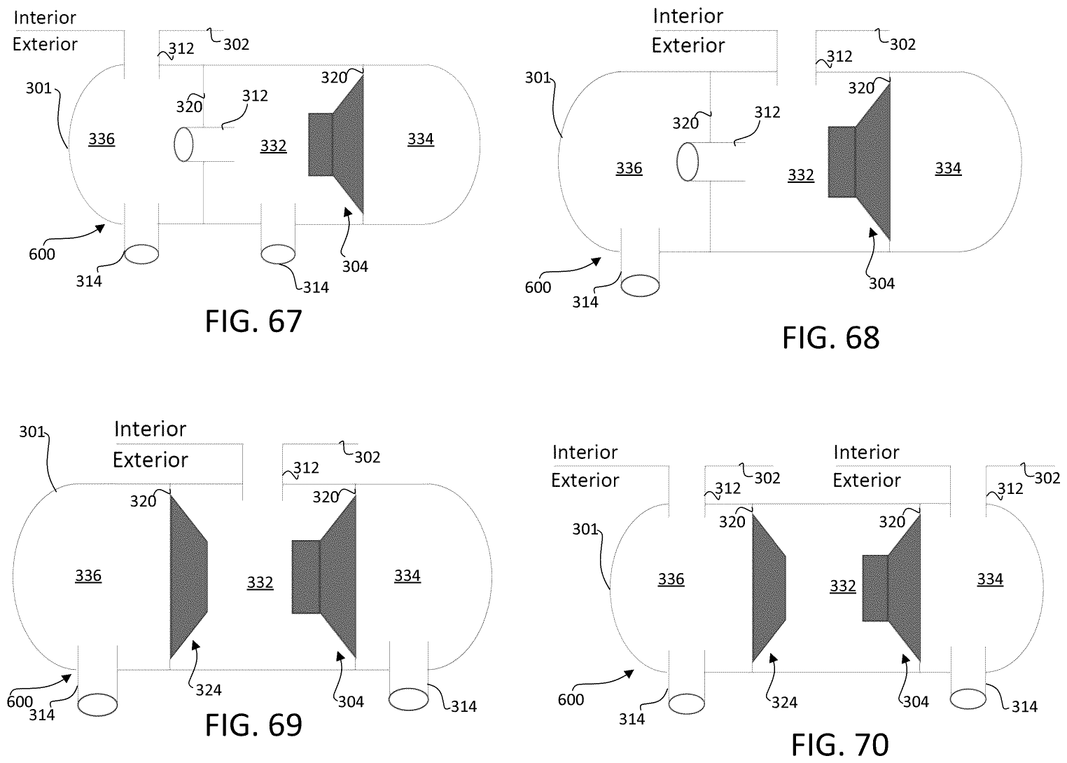

FIG. 50 illustrates that the first chamber 332 can include an active acoustic radiator 304 and/or passive acoustic radiator 324. An exterior port pipe 314 can connect to the second chamber 334. An interior port pipe 312 can connect to the third chamber 336. FIG. 51 shows that an exterior port pipe 314 can also be connected to the second chamber 334. FIG. 52 illustrates that an interior port pipe 312 can connect to the third chamber 336. FIG. 53 illustrates interior port pipes 312 connecting to the second chamber 334 and third chamber 336. FIG. 54 illustrates an active acoustic radiator 304 in the second chamber 334 and an interior port pipe 312 and exterior port pipe 314 connecting to the third chamber 336. An interior port pipe 312 can connect the first chamber 332 and the third chamber 336. FIG. 55 illustrates an exterior port pipe 314 connecting to the first chamber 332, an active acoustic radiator 304 in the second chamber 334, an interior port pipe 312 connecting to the third chamber 336, and an interior port pipe 312 connecting the first chamber 332 and the third chamber 336. FIG. 56 illustrates an active acoustic radiator 304 in the first chamber 332, an exterior port pipe 314 connecting to the second chamber 334, an interior port pipe 312 connecting to the third chamber 336, and an interior port pipe 312 connecting the first chamber 332 and the third chamber 336. FIG. 57 shows exterior port pipes 314 connecting to the first chamber 332 and third chamber 336. FIG. 58 shows an interior port pipe 312 connecting to the first chamber 332. FIG. 59 shows an interior port pipe 312 connecting to the second chamber 334. FIG. 60 illustrates interior port pipes 312 connected to the first chamber 332 and third chamber 336. FIG. 61 illustrates exterior port pipe 314 connecting to the first chamber 332 and the second chamber 334. FIG. 62 shows exterior port pipe 314 connected to the first chamber 332, second chamber 334, and third chamber 336. FIG. 63 shows interior port pipes 312 connecting to the first chamber 332 and second chamber 334 and exterior port pipes 314 connecting to the first chamber 332 and third chamber 336. FIG. 64 illustrates the interior port pipes 312 and exterior port pipes 314 connecting to the first chamber 332 and second chamber 334. FIG. 65 shows exterior port pipes 314 connecting to the first chamber 332, second chamber 334, and third chamber 336. FIG. 66 shows interior port pipes 312 and exterior port pipes 314 connecting to the first chamber 332, second chamber 334, and third chamber 336. FIG. 67 shows an interior port pipe 312 connecting to the third chamber 336 and exterior port pipes 314 connecting to the first chamber 332 and third chamber 336. FIG. 68 illustrates an interior port pipe 312 connecting to the first chamber 332 and an exterior port pipe 314 to the third chamber 336. FIG. 69 illustrates the first chamber 332 with an active acoustic radiator 304 and passive acoustic radiator 324, an interior port pipe 312 connecting to the first chamber 332, and exterior port pipes 314 connecting to the second chamber 334 and third chamber 336. FIG. 70 illustrates interior port pipes 312 and exterior port pipes 314 connecting to the second chamber 334 and third chamber 336.

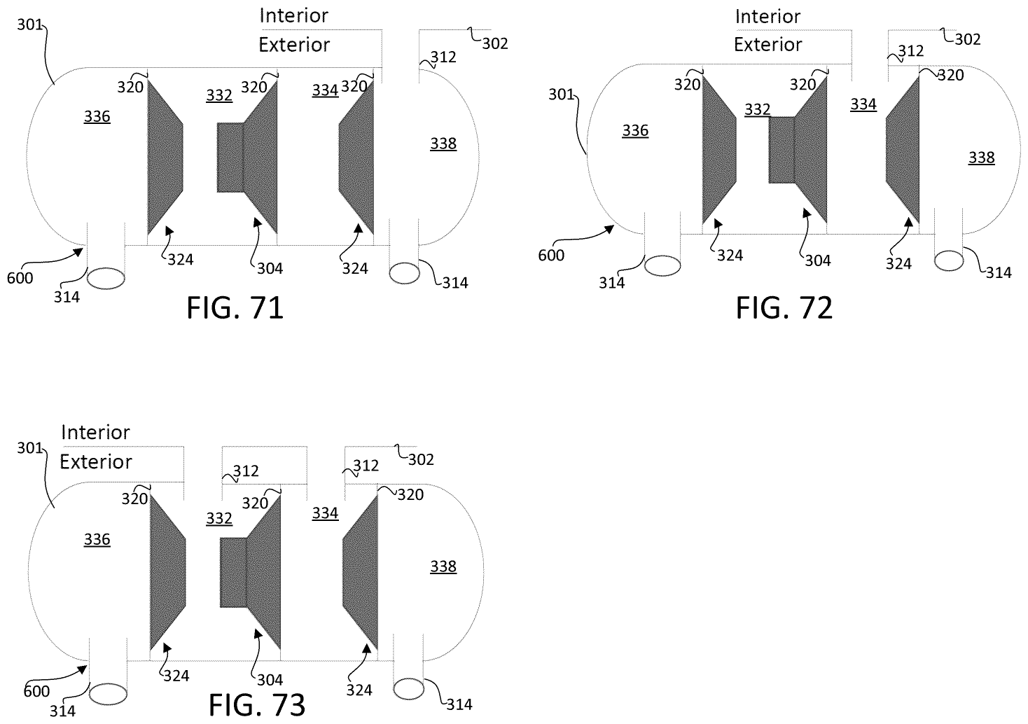

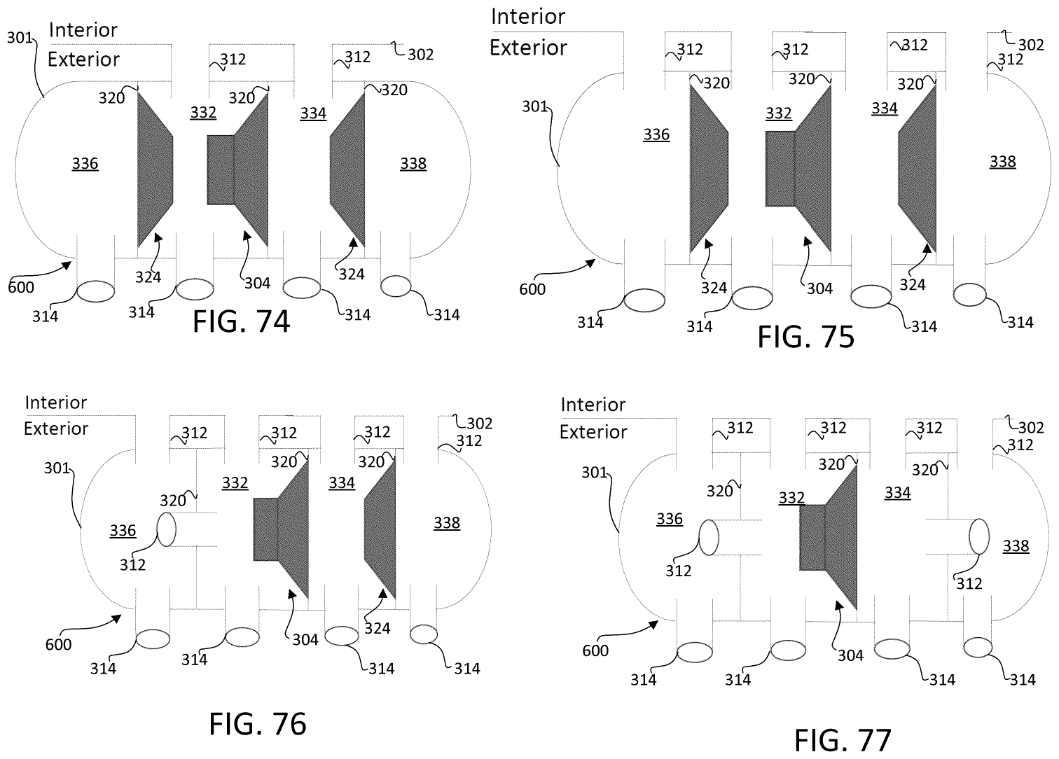

FIG. 71 shows the loudspeaker system 600 with a pressure vessel 301 with four chambers. The first chamber 332 includes an active acoustic radiator 304 and passive acoustic radiator 324. The second chamber 334 includes a passive acoustic radiator 324. An interior port pipe 312 connects to the fourth chamber 338. Exterior port pipes 314 connect to the third chamber 336 and fourth chamber 338. FIG. 72 shows an interior port pipe 312 connecting to the second chamber 334. FIG. 73 shows interior port pipes 312 connecting to the first chamber 332 and second chamber 334. FIG. 74 shows interior port pipes 312 connecting to the first chamber 332 and second chamber 334 and exterior port pipes 314 connecting to the first chamber 332, second chamber 334, third chamber 336, and fourth chamber 338. FIG. 75 shows interior port pipes 312 and exterior port pipes 314 connecting to the first chamber 332, second chamber 334, third chamber 336, and fourth chamber 338. FIG. 76 shows an interior port pipe 312 connecting the first chamber 332 and third chamber 336. FIG. 77 shows an interior port pipe 312 connecting the second chamber 334 and fourth chamber 338.

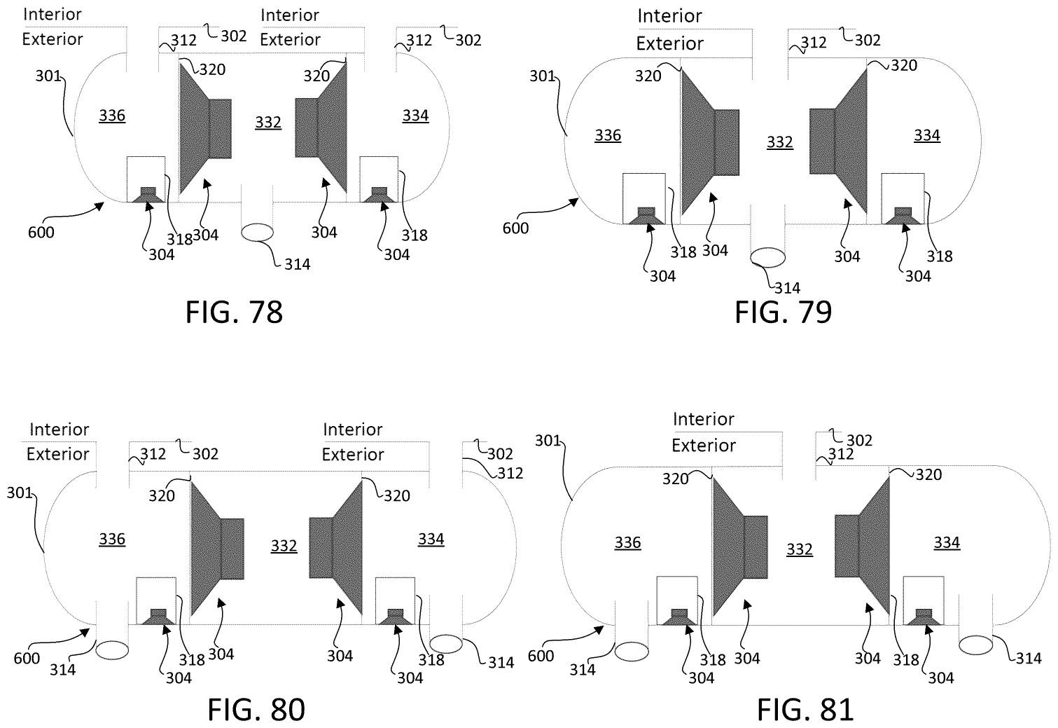

FIG. 78 shows the loudspeaker system 600 with a pressure vessel 301 with three chambers. The first chamber 332 includes two active acoustic radiators 304 and an exterior port pipe 314. Interior port pipes 312 can connect to the second chamber 334 and third chamber 336. The second chamber 334 and third chamber 336 can include auxiliary chambers 318 with active acoustic radiators 304 configured to generate and transmit acoustic emissions into an environment. FIG. 79 shows an interior port pipe 312 connecting to the first chamber 332. FIG. 80 shows interior port pipes 312 and exterior port pipes 314 connecting to the second chamber 334 and third chamber 336. FIG. 81 shows an interior port pipe 312 connecting to the first chamber 332 and exterior port pipes 314 connecting to the second chamber 334 and third chamber 336.

The port pipes can serve as acoustic masses, as described herein. Accordingly, they can be used to obtain resonant tuning frequencies, such as corresponding resonant tuning frequencies, which may be chosen to be the same or different from one another as required by the application. Other combinations are described herein and illustrated in the various Figures.

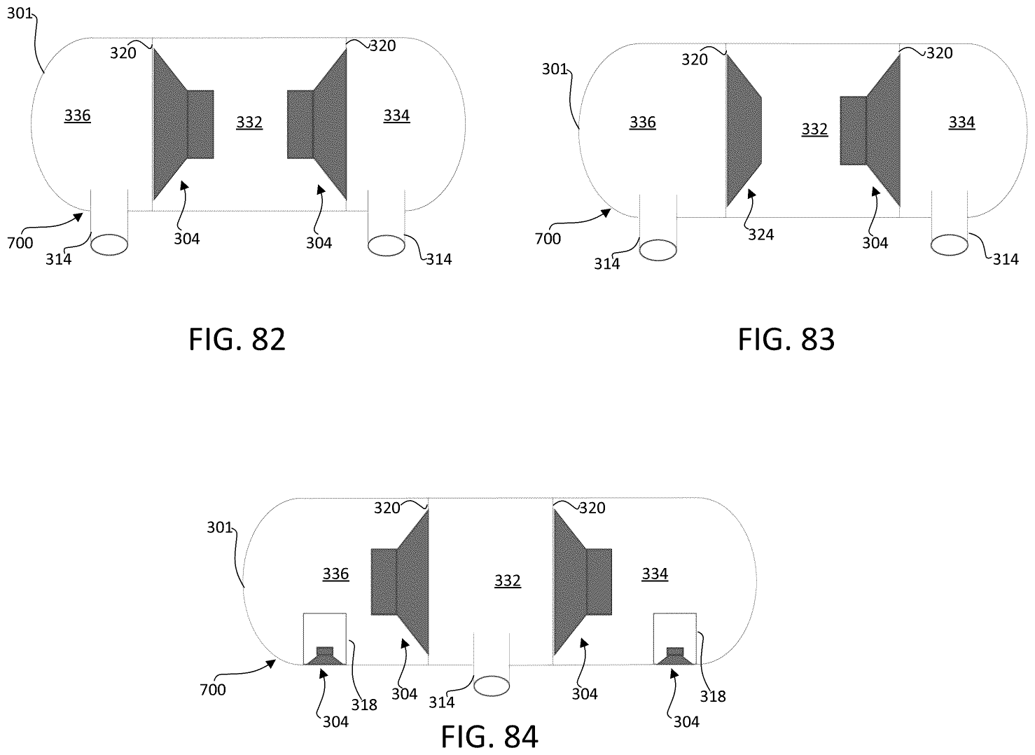

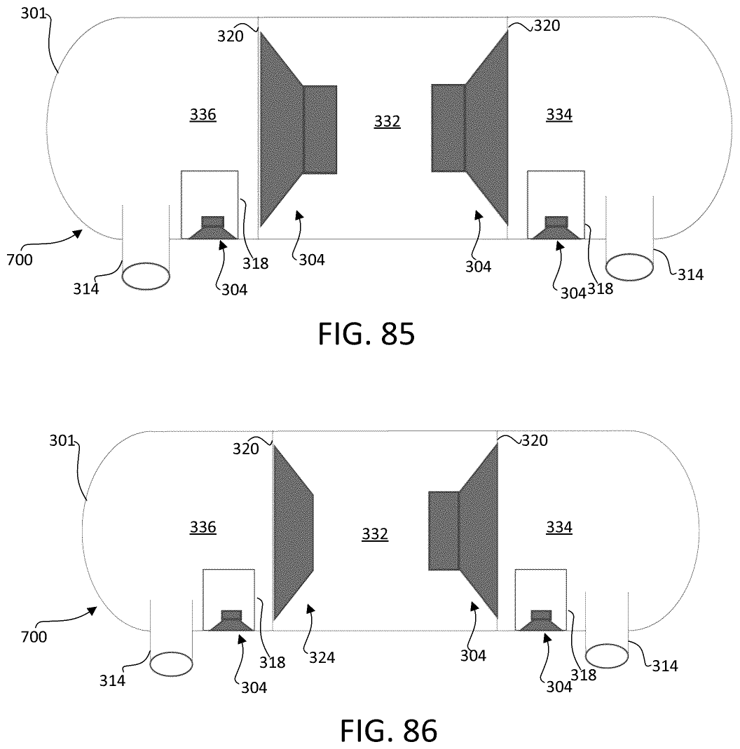

FIGS. 82-86 show schematic diagrams of example prior art loudspeaker systems 700 with pressure vessels 301 having one or more port tubes to an exterior of a vehicle enclosure. In the embodiments shown here, no acoustic channels (e.g., accessory air path, vent, port pipe) that connect an interior of the vehicle enclosure 302 are included in these examples. Accordingly, these examples would be directed primarily toward generating and/or transmitting acoustic emissions outside the pressure vessel 301 into a surrounding environment, but not simultaneously into a vehicle interior and exterior in any directed manner as provided by the novel claims of the present invention. Because these embodiments do not generate in-phase acoustic radiation both inside and outside of a vehicle interior simultaneously, they do not represent novel developments and are outside the scope of the novel claims provided. FIG. 82 illustrates a loudspeaker system 700 with a pressure vessel 301 with three chambers. The first chamber 332 includes two active acoustic radiators 304. The second chamber 334 includes an exterior port pipe 314. The third chamber 336 includes an exterior port pipe 314. This arrangement, as illustrated in FIG. 82, is a dual-driver version of a previously-known 4^{th}-order bandpass configuration. FIG. 83 illustrates that the first chamber 332 may include an active acoustic radiator 304 and a passive acoustic radiator 324. FIG. 84 illustrates that the second chamber 334 and third chamber 336 may include active acoustic radiators 304 and auxiliary chambers 318 with active acoustic radiator 304 configured to generate and direct acoustic emissions directly into the environment. FIG. 85 illustrates the second chamber 334 and the third chamber 336 with the auxiliary chambers 318 and the active acoustic radiator 304 therein but with the two active acoustic radiator 304 in the first chamber 332. FIG. 86 illustrates the first chamber 332 with an active acoustic radiator 304 and a passive acoustic radiator 324.

### EXAMPLE EMBODIMENTS

Some nonlimiting example embodiments described herein are provided below. These examples should not be viewed as constricting or narrowing the interpretation of any disclosure herein but are provided for illustrative purposes.

Example 1. A loudspeaker system comprising: a pressure vessel disposed outside a vehicle enclosure, the pressure vessel configured to maintain a controlled environment different from an environment outside both the pressure vessel and the vehicle enclosure; an active acoustic radiator disposed within the pressure vessel and configured to radiate acoustic emissions outside the vehicle enclosure, the active acoustic radiator comprising a magnetic circuit, a moveable diaphragm, and a voice coil; an acoustic channel configured to fluidly connect an interior of the pressure vessel with an interior of the vehicle enclosure, the acoustic channel configured to radiate acoustic emissions into the interior of the vehicle enclosure that are in-phase with the acoustic emissions generated by the active acoustic radiator; and a vent connecting the interior of the pressure vessel to the environment outside both the pressure vessel and the vehicle enclosure, the vent configured to radiate a portion of the acoustic emissions generated by the rear side of the active acoustic radiator into the environment.

Example 2. The loudspeaker system of Example 1, wherein the acoustic channel comprises an accessory air path.

Example 3. The loudspeaker system of Example 1, wherein the acoustic channel comprises a port pipe.

Example 4. The loudspeaker system of Example 1, wherein the vent comprises a port pipe.

Example 5. The loudspeaker system of Example 1, wherein the vent is configured to form a resonant tuning frequency.

Example 6. The loudspeaker system of Example 1, wherein the vent has an elliptical or rectangular cross-section.

Example 7. The loudspeaker system of Example 1, further comprising a particulate barrier disposed within the acoustic channel, the particulate barrier configured to reduce transmission of particulate matter from passing between the pressure vessel and the vehicle enclosure.

Example 8. The loudspeaker system of Example 7, wherein the particulate barrier comprises at least one of a grille, a semi-permeable membrane, a foam, a valve, or a breather assembly configured to form a fluid barrier in response to becoming wet.

Example 9. The loudspeaker system of Example 1, further comprising a fluid barrier disposed between the environment and the magnetic circuit, the fluid barrier configured to prevent fluid flow between the environment and the magnetic circuit.

Example 10. The loudspeaker system of Example 9, wherein the fluid barrier comprises at least one of a semi-permeable membrane, a foam, a valve, a movable or expandable diaphragm, or a breather assembly configured to form the fluid barrier in response to becoming wet.

Example 11. The loudspeaker system of Example 1, wherein the transducer forms at least a portion of the pressure vessel or is connected to the pressure vessel.

Example 12. The loudspeaker system of Example 11, wherein the transducer forms a fluid barrier between the environment and the magnetic circuit, the fluid barrier configured to prevent fluid flow between the environment and the magnetic circuit.

Example 13. The loudspeaker system of Example 1, wherein the transducer comprises a plurality of transducers mechanically coupled to a magnetic circuit.

Example 14. The loudspeaker system of Example 1, wherein the loudspeaker system is configured to be removably coupled to the vehicle.

Example 15. The loudspeaker system of Example 1, wherein the pressure vessel comprises a partition separating a first chamber from a second chamber of the pressure vessel.

Example 16. The loudspeaker system of Example 15, wherein the transducer of the active acoustic radiator is disposed within the first chamber of the pressure vessel.

Example 17. The loudspeaker system of Example 16, wherein the magnetic circuit and the transducer are disposed within the first chamber of the pressure vessel.

Example 18. The loudspeaker system of Example 15, wherein the transducer forms at least a portion of the partition or is connected to the partition.

Example 19. The loudspeaker system of Example 18, wherein the transducer forms a fluid barrier between the first chamber and the second chamber, the fluid barrier configured to prevent fluid flow between the first chamber and the second chamber.

Example 20. The loudspeaker system of Example 18, wherein the transducer is configured to radiate antiphase acoustic emissions into the first chamber of the pressure vessel, the antiphase acoustic emissions having an opposite phase with the acoustic emissions radiated by the transducer into the second chamber.

Example 21. The loudspeaker system of Example 15, wherein the acoustic channel connects the second chamber with the interior of the vehicle enclosure.

Example 22. The loudspeaker system of Example 15, wherein the vent connects the second chamber with the environment outside both the pressure vessel and the vehicle enclosure.

Example 23. The loudspeaker system of Example 15, wherein the vent is configured to form an acoustic bandpass filter from the second chamber to the environment.

Example 24. The loudspeaker system of Example 15, wherein the acoustic channel is configured to form an acoustic bandpass filter from the second chamber to the interior of the vehicle enclosure.

Example 25. The loudspeaker system of Example 15, further comprising a second vent connecting the first chamber with the environment outside both the pressure vessel and the vehicle enclosure.

Example 26. The loudspeaker system of Example 25, wherein the second vent is configured to form an acoustic bandpass filter from the first chamber to the environment outside both the pressure vessel and the vehicle enclosure.

Example 27. The loudspeaker system of Example 15, further comprising a passive acoustic radiator comprising a second moveable diaphragm, the passive acoustic radiator disposed within the pressure vessel of the loudspeaker system.

Example 28. The loudspeaker system of Example 27, wherein the passive acoustic radiator is disposed within the first chamber of the pressure vessel.

Example 29. The loudspeaker system of Example 27, wherein the passive acoustic radiator forms at least a portion of the partition or is connected to the partition.

Example 30. The loudspeaker system of Example 29, wherein the passive acoustic radiator forms a fluid barrier between the first chamber and the second chamber, the fluid barrier configured to prevent fluid flow between the first chamber and the second chamber.

Example 31. The loudspeaker system of Example 29, wherein the active acoustic radiator forms at least a portion of the partition or is connected to the partition.

Example 32. The loudspeaker system of Example 27, wherein the passive acoustic radiator is configured to form a first resonant tuning frequency.

Example 33. The loudspeaker system of Example 32, wherein the vent is configured to form a second resonant tuning frequency.

Example 34. The loudspeaker system of Example 33, wherein the second resonant tuning frequency is different from the first resonant tuning frequency.

Example 35. The loudspeaker system of Example 27, wherein the pressure vessel further comprises a second partition separating the first chamber from a third chamber.

Example 36. The loudspeaker system of Example 35, wherein the passive acoustic radiator forms at least a portion of the second partition or is connected to the second partition.

Example 37. The loudspeaker system of Example 35, wherein the acoustic channel is configured to fluidly connect the third chamber with the interior of the vehicle enclosure.

Example 38. The loudspeaker system of Example 35, wherein the acoustic channel is configured to fluidly connect the second chamber with the interior of the vehicle enclosure.

Example 39. The loudspeaker system of Example 35, further comprising a second vent connecting the third chamber with the environment outside both the pressure vessel and the vehicle enclosure.

Example 40. A loudspeaker system comprising: a pressure vessel disposed outside a vehicle enclosure, the pressure vessel configured to maintain a controlled environment different from an environment outside both the pressure vessel and the vehicle enclosure; an active acoustic radiator disposed within the pressure vessel and configured to radiate acoustic emissions outside the vehicle enclosure, the active acoustic radiator comprising magnetic circuit, a moveable diaphragm, and a voice coil; a passive acoustic radiator comprising a second moveable diaphragm, the passive acoustic radiator disposed within the pressure vessel of the loudspeaker system and configured to radiate acoustic emissions into an interior of the vehicle enclosure; and a vent connecting an interior of the pressure vessel to the environment outside both the pressure vessel and the vehicle enclosure, the vent configured to radiate the acoustic emissions generated by the active acoustic radiator into the environment.

Example 41. The loudspeaker system of Example 40, wherein the passive acoustic radiator is configured to form a first resonant tuning frequency.

Example 42. The loudspeaker system of Example 40, further comprising an acoustic channel configured to fluidly connect the interior of the pressure vessel with an interior of the vehicle enclosure, the acoustic channel configured to radiate acoustic emissions into the interior of the vehicle enclosure that are in-phase with the acoustic emissions generated by the active acoustic radiator.

Example 43. The loudspeaker system of Example 40, wherein the pressure vessel comprises a partition separating a first chamber from a second chamber of the pressure vessel.

Example 44. The loudspeaker system of Example 43, wherein the passive acoustic radiator is disposed within the first chamber of the pressure vessel.

Example 45. The loudspeaker system of Example 43, wherein the passive acoustic radiator forms at least a portion of the partition or is connected to the partition.

Example 46. The loudspeaker system of Example 45, wherein the passive acoustic radiator forms a fluid barrier between the first chamber and the second chamber, the fluid barrier configured to prevent fluid flow between the first chamber and the second chamber.

Example 47. The loudspeaker system of Example 46, wherein the transducer forms at least a portion of the partition or is connected to the partition.

Example 48. A loudspeaker system comprising: a pressure vessel disposed outside a vehicle enclosure, the pressure vessel configured to maintain a controlled environment different from an environment outside both the pressure vessel and the vehicle enclosure, the pressure vessel comprising a partition separating a first chamber from a second chamber of the pressure vessel; an active acoustic radiator disposed within the pressure vessel and configured to radiate acoustic emissions outside the vehicle enclosure, the active acoustic radiator comprising magnetic circuit, a moveable diaphragm, and a voice coil; an acoustic channel comprising an accessory air path configured to fluidly connect the second chamber with an interior of the vehicle enclosure, the acoustic channel configured to radiate acoustic emissions into the interior of the vehicle enclosure that are in-phase with the acoustic emissions generated by the active acoustic radiator; a particulate barrier disposed within the acoustic channel, the particulate barrier configured to reduce transmission of particulate matter from passing between the pressure vessel and the vehicle enclosure, wherein the particulate barrier comprises a semi-permeable membrane; and a vent connecting an interior of the pressure vessel to the environment outside both the pressure vessel and the vehicle enclosure, the vent configured to radiate the acoustic emissions generated by the active acoustic radiator into the environment.

Example 49. The loudspeaker system of Example 48, wherein the transducer forms a fluid barrier between the second chamber and the first chamber, the fluid barrier configured to prevent fluid flow between the second chamber and the first chamber.

Example 50. The loudspeaker system of Example 48, wherein the acoustic channel is configured to form an acoustic bandpass filter from the second chamber to the interior of the vehicle enclosure.

Example 51. The loudspeaker system of Example 48, further comprising a second vent connecting the first chamber with the environment outside both the pressure vessel and the vehicle enclosure.

Example 52. The loudspeaker system of Example 51, wherein the second vent is configured to form an acoustic bandpass filter from the first chamber to the environment outside both the pressure vessel and the vehicle enclosure.

Example 53. A loudspeaker system comprising: a pressure vessel disposed outside a vehicle enclosure, the pressure vessel configured to maintain a controlled environment different from an environment outside both the pressure vessel and the vehicle enclosure, the pressure vessel comprising a partition separating a first chamber from a second chamber of the pressure vessel; an active acoustic radiator disposed within the pressure vessel and configured to radiate acoustic emissions outside the vehicle enclosure, the active acoustic radiator comprising magnetic circuit, a moveable diaphragm, and a voice coil; an acoustic channel comprising a port tube configured to fluidly connect the second chamber with an interior of the vehicle enclosure, the acoustic channel configured to radiate acoustic emissions into the interior of the vehicle enclosure that are in-phase with the acoustic emissions generated by the active acoustic radiator; and a vent connecting an interior of the pressure vessel to the environment outside both the pressure vessel and the vehicle enclosure, the vent configured to radiate the acoustic emissions generated by the active acoustic radiator into the environment.

Example 54. The loudspeaker system of Example 53, wherein the transducer forms a fluid barrier between the second chamber and the first chamber, the fluid barrier configured to prevent fluid flow between the second chamber and the first chamber.

Example 55. The loudspeaker system of Example 53, wherein the port tube is configured to form an acoustic bandpass filter from the second chamber to the interior of the vehicle enclosure.

Example 56. A loudspeaker system comprising: a pressure vessel disposed outside a vehicle enclosure, the pressure vessel configured to maintain a controlled environment different from an environment outside both the pressure vessel and the vehicle enclosure, the pressure vessel comprising: a partition separating a first chamber from a second chamber of the pressure vessel; and a second partition separating the first chamber from a third chamber; an active acoustic radiator disposed within the first chamber and configured to radiate acoustic emissions into the second chamber, the active acoustic radiator comprising magnetic circuit, a moveable diaphragm, and a voice coil; a passive acoustic radiator comprising a second moveable diaphragm, the passive acoustic radiator disposed within the first chamber and configured to radiate acoustic emissions into the third chamber; an acoustic channel comprising an accessory air path configured to fluidly connect an interior of the pressure vessel with an interior of the vehicle enclosure; a vent connecting the second chamber to the environment outside both the pressure vessel and the vehicle enclosure, the vent configured to radiate the acoustic emissions generated by the active acoustic radiator into the environment; and a second vent connecting the third chamber to the environment, the second vent configured to radiate the acoustic emissions generated by the passive acoustic radiator into the environment.

Example 57. The loudspeaker system of Example 56, wherein the acoustic channel to the interior of the vehicle enclosure is configured to radiate acoustic emissions into the interior of the vehicle enclosure that are in-phase with the acoustic emissions generated by the active acoustic radiator.

Example 58. The loudspeaker system of Example 56, wherein the accessory air path connects the second chamber with the interior of the vehicle enclosure.

Example 59. The loudspeaker system of Example 56, wherein the accessory air path connects the third chamber with the interior of the vehicle enclosure.

Example 60. A loudspeaker system comprising: a pressure vessel disposed outside a vehicle enclosure, the pressure vessel configured to maintain a controlled environment different from an environment outside both the pressure vessel and the vehicle enclosure, the pressure vessel comprising: a partition separating a first chamber from a second chamber of the pressure vessel; and a second partition separating the first chamber from a third chamber; an active acoustic radiator disposed within the first chamber and configured to radiate acoustic emissions into the second chamber, the active acoustic radiator comprising magnetic circuit, a moveable diaphragm, and a voice coil; a passive acoustic radiator comprising a second moveable diaphragm, the passive acoustic radiator disposed within the first chamber and configured to radiate acoustic emissions into the third chamber; and an acoustic channel comprising a port pipe configured to fluidly connect the second chamber with an interior of the vehicle enclosure.

Example 61. The loudspeaker system of Example 60, wherein the acoustic channel is configured to radiate acoustic emissions into the interior of the vehicle enclosure that are in-phase with the acoustic emissions generated by the active acoustic radiator.

Example 62. The loudspeaker system of Example 60, wherein the transducer forms a fluid barrier between the second chamber and the first chamber, the fluid barrier configured to prevent fluid flow between the second chamber and the first chamber.

Example 63. The loudspeaker system of Example 60, wherein the passive acoustic radiator forms a fluid barrier between the third chamber and the first chamber, the fluid barrier configured to prevent fluid flow between the third chamber and the first chamber.

Example 64. The loudspeaker system of Example 60, further comprising a vent connecting the third chamber to the environment outside both the pressure vessel and the vehicle enclosure, the vent configured to radiate the acoustic emissions generated by the passive acoustic radiator into the environment.

Example 65. The loudspeaker system of Example 64, further comprising a second vent connecting the third chamber to the environment, the second vent configured to radiate the acoustic emissions generated by the passive acoustic radiator into the environment.

Example 66. The loudspeaker system of Example 60, wherein the acoustic channel is configured to form an acoustic bandpass filter from the second chamber to the interior of the vehicle enclosure.

What is claimed is:

1. A loudspeaker system comprising:
a pressure vessel disposed outside a vehicle enclosure, the pressure vessel configured to maintain a controlled environment different from an environment outside both the pressure vessel and the vehicle enclosure;
an active acoustic radiator disposed within the pressure vessel and configured to radiate acoustic emissions outside the vehicle enclosure, the active acoustic radiator comprising a magnetic circuit, a moveable diaphragm, and a voice coil;
an acoustic channel configured to fluidly connect an interior of the pressure vessel with an interior of the vehicle enclosure, the acoustic channel configured to radiate acoustic emissions into the interior of the vehicle enclosure that are in-phase with the acoustic emissions generated by the active acoustic radiator; and
a vent connecting the interior of the pressure vessel to the environment outside both the pressure vessel and the vehicle enclosure, the vent configured to radiate the acoustic emissions generated by the active acoustic radiator into the environment.

2. The loudspeaker system of claim 1, wherein the acoustic channel comprises an accessory air path.

3. The loudspeaker system of claim 1, wherein the acoustic channel comprises a port pipe.

4. The loudspeaker system of claim 1, wherein the vent comprises a port pipe.

5. The loudspeaker system of claim 1, further comprising a particulate barrier disposed within the acoustic channel, the particulate barrier configured to reduce transmission of particulate matter from passing between the pressure vessel and the vehicle enclosure.

6. The loudspeaker system of claim 5, wherein the particulate barrier comprises at least one of a grille, a semi-permeable membrane, a foam, a valve, a movable diaphragm, or a breather assembly configured to form a fluid barrier in response to becoming wet.

7. The loudspeaker system of claim 1, further comprising a fluid barrier disposed between the environment and the magnetic circuit, the fluid barrier configured to prevent fluid flow between the environment and the magnetic circuit.

8. The loudspeaker system of claim 7, wherein the fluid barrier comprises at least one of a semi-permeable membrane, a foam, a valve, or a breather assembly configured to form the fluid barrier in response to becoming wet.

9. The loudspeaker system of claim 1, wherein the pressure vessel comprises a partition separating a first chamber from a second chamber of the pressure vessel.

10. The loudspeaker system of claim 9, wherein the magnetic circuit of the active acoustic radiator is disposed within the first chamber of the pressure vessel.

11. The loudspeaker system of claim 9, wherein the acoustic radiator forms at least a portion of the partition or is connected to the partition.

12. The loudspeaker system of claim 11, wherein the acoustic radiator is configured to radiate antiphase acoustic emissions into the first chamber of the pressure vessel, the antiphase acoustic emissions having an opposite phase than the acoustic emissions radiated by the acoustic radiator into the second chamber.

13. The loudspeaker system of claim 9, wherein the acoustic channel connects the second chamber with the interior of the vehicle enclosure.

14. The loudspeaker system of claim 9, further comprising a passive acoustic radiator comprising a second moveable diaphragm, the passive acoustic radiator disposed within the pressure vessel of the loudspeaker system.

15. The loudspeaker system of claim 14, wherein the pressure vessel further comprises a second partition separating the first chamber from a third chamber.

16. The loudspeaker system of claim 15, wherein the passive acoustic radiator forms at least a portion of the second partition or is connected to the second partition.

17. The loudspeaker system of claim 15, further comprising a second vent connecting the third chamber with the environment outside both the pressure vessel and the vehicle enclosure.

18. A loudspeaker system comprising:
a pressure vessel disposed outside a vehicle enclosure, the pressure vessel configured to maintain a controlled environment different from an environment outside both the pressure vessel and the vehicle enclosure;
an active acoustic radiator disposed within the pressure vessel and configured to radiate acoustic emissions outside the vehicle enclosure, the active acoustic radiator comprising a magnetic circuit, a moveable diaphragm, and a voice coil;
a passive acoustic radiator comprising a second moveable diaphragm, the passive acoustic radiator disposed within the pressure vessel of the loudspeaker system and configured to radiate acoustic emissions into an interior of the vehicle enclosure; and
a vent connecting an interior of the pressure vessel to the environment outside both the pressure vessel and the vehicle enclosure, the vent configured to radiate the acoustic emissions generated by the active acoustic radiator into the environment.

19. The loudspeaker system of claim 18, further comprising an acoustic channel configured to fluidly connect the interior of the pressure vessel with an interior of the vehicle enclosure, the acoustic channel configured to radiate acoustic emissions into the interior of the vehicle enclosure that are in-phase with the acoustic emissions generated by the active acoustic radiator.

20. A loudspeaker system comprising:
a pressure vessel disposed outside a vehicle enclosure, the pressure vessel configured to maintain a controlled environment different from an environment outside both the pressure vessel and the vehicle enclosure, the pressure vessel comprising a partition separating a first chamber from a second chamber of the pressure vessel;
an active acoustic radiator disposed within the pressure vessel and configured to radiate acoustic emissions outside the vehicle enclosure, the active acoustic radiator comprising a magnetic circuit, a moveable diaphragm, and a voice coil;
an acoustic channel comprising an accessory air path configured to fluidly connect the second chamber with an interior of the vehicle enclosure, the acoustic channel configured to radiate acoustic emissions into the interior of the vehicle enclosure that are in-phase with the acoustic emissions generated by the active acoustic radiator;
a particulate barrier disposed within the acoustic channel, the particulate barrier configured to reduce transmission of particulate matter from passing between the pressure vessel and the vehicle enclosure, wherein the particulate barrier comprises a semi-permeable membrane; and
a vent connecting an interior of the pressure vessel to the environment outside both the pressure vessel and the vehicle enclosure, the vent configured to radiate the acoustic emissions generated by the active acoustic radiator into the environment.
